(19) United States
(12) Patent Application Publication
(10) Pub. No.: US 2013/0054656 A1
(43) Pub. Date: Feb. 28, 2013

(54) Useful, Practical, and Market-Ready Handheld Library for Students

(71) Applicant: Vincent Paul Conroy, Fort Washington, MD (US)

(72) Inventor: Vincent Paul Conroy, Fort Washington, MD (US)

(21) Appl. No.: 13/218,381

(22) Filed: Aug. 25, 2011

(51) Int. Cl. G06F 17/30; G06F 1/16

(52) U.S. Cl. 707/821; 707/E17.001

(57) ABSTRACT

An electronic handheld library is disclosed that fully replaces hard copy textbooks and references, audio-visual materials, and successor instructional materials, and receives, stores, and displays other digital data in electronic form. In a single fully integrated design the handheld library meets all six of the specific requirements for a successful launch, development, and operation, specifically focusing on the real requirement; providing excellent presentation quality; possessing inherent high resistance to accidental damage; possessing inherent high theft resistance; providing protection of the source, data, user, and handheld library itself from malicious or accidental events; and providing affordability equal to or better than the objects replaced. Compared to what it replaces, it provides significant advantages for institutional financial management and for students' health.

### CROSS-REFERENCE TO RELATED APPLICATIONS

Not applicable

### FEDERALLY SPONSORED RESEARCH

Not applicable

### SEQUENCE LISTING

Not applicable

### BACKGROUND OF THE INVENTION

1. Field of Invention

This invention generally relates to the field of school system educational tools and to the media for texts and references, specifically the replacement of text books and reference books, and ultimately of audio-visual playback systems and other macroscopic displays, via handheld library devices.

2. Prior Art

For fiscal and health reasons the time has come to replace hard copy text books with portable electronic devices. Rising text book prices, the growing length of the lists of required text books and references, and the frequency at which the materials are superseded by newer versions increasingly challenge school budgets to provide up-to-date resources. In parallel to these developments the weight and bulk of the materials that students are nominally expected to routinely transport between classes, home, and school has grown to unhealthy amounts. Even the use of backpacks does not accommodate all the cargo. Children go to and from school looking like infantry headed for maneuvers.

Among governmental agencies school systems may have the most extensive, most enduring, and most intensely emotional interfaces with the general population. Parents want the best for their kids and can be both illogical and highly demonstrative in their behalf. Therefore schools want to please them. Schools are also one of the major spenders of the local budgets, though, so their operations are constantly being scrutinized for unnecessary and unjustified expenses. Innovators can expect strong challenges. The citizenry frequently holds concepts of what is normal and desirable in a school system that are rooted in their own experiences of 10 to 40 years prior. Moreover, failed projects and other mistakes are very popular with the news media, and big mistakes or questionable decisions can even become an item in the late night talk show hosts' monologs. Most school systems, being particularly attuned to local public perceptions of good and bad judgment, do not court people who may want to launch career threatening initiatives.

As a result, in marketing terms school systems are the antithesis of early adopters. Their main product is a service which is more dependent on individual skill and demographics than the physical tools available, given that minimum acceptable conditions have been established. They are very deliberate about taking up new products and systems, especially when the change is to replace a staple of historic usage like text books. Most innovation is in advances by consensually agreed extensions of traditional practices. Examples of such are extensions of techniques for teaching reading and extensions of techniques to get the students more involved in teaching themselves and their neighbors in the classroom.

Some school systems today are looking to various types of electronic educational support devices and systems. They are doing so in order to reduce costs and to achieve greater instructional effectiveness. The politically powerful requirements to save tax money and to demonstrate improved scholastic results buttress these efforts. Unfortunately neither of the two main thrusts will meet the real needs with regard to text book replacement.

The first axis of advance is in computer-based, interactive instructional systems. Besides having shortcomings which are identified in the Prior Art, such systems will be too expensive to be widely distributed for some time. The second axis is to issue laptops or e-reader electronic novel readers to students. Neither laptops nor e-readers meet the actual requirements of the target market because they lack critical features which will be identified in Prior Art. E-readers in fact bring with them a new medical affliction that stems from their inherent limitations.

Prior art in this field includes both previously patented inventions and products currently available in the public and defense markets. The shortcoming of all these systems is that they do not offer a complete solution to the requirement. They are not compatible with the full set of the human and fiscal requirements of school systems from elementary school through high school.

All these factors together mean that the various members of the school system market community will have trouble envisioning, documenting, and developing a dedicated and unique portable electronic textbook replacement device. Furthermore, if the attempts underway now and similar experiments fail conspicuously, exaggerated barriers may be created toward any subsequent attempts for an extended period.

The direct answer to the hard copy textbook problems is a handheld, portable, electronic receiver, storage, and display device that can play any of the textbooks required while being both compatible with the school system environment and affordable. Such a device would replace every book, and it would be virtually useless for diversion to any usage except as a school book replacement device. The differences between this device and a number of superficially similar products in existence, though, are not obvious, especially when the full range of requirements is considered. It is not assured that current e-book and tablet computer suppliers will accurately perceive the full range and scope of actual needs in this highly parochial market, properly document the requirements, and then hit the market with an immediate success.

In a related plane of business and government a similar need exists to reduce the acquisition, storage, and other life cycle burdens of technical manuals, instructions, policies, and published materials in reference libraries in general. Past remedies have included the use of microfiche and microfiche readers and the use of desktop computers. Both of these help to a degree, but each has disadvantages. Not all references and circulating materials are available on microfiche, and creating new microfiche archives as a special project is expensive. Desktop computers in libraries have much more capability than is needed for the single task of providing access to materials in digital form. Consequently they are much more expensive than necessary, and fewer of them can be purchased than may be needed. Furthermore they take up a lot of space even when only the keyboard, mouse, and display are on the table. Laptop computers are more compact, but they are even more expensive, and they are highly pilferable. A durable, versatile handheld library would save enormous space, power, and cost throughout the systems which deploy it over the whole life cycle.

Before considering the existing inventions and systems in the Prior Art it is necessary to recognize and define some contextual constraints. These include the electronic architecture into which the book replacement machines must fit and the system requirements and existing standards for design and test of the book replacement devices.

### Requirements for the Hard Copy Text Book Replacement Device

School systems' hard copy textbook replacement devices have six major requirements and four lesser requirements. For successful implementation of the handheld library concept as a solution to the problems cited all the major requirements must be met. The lesser requirements are related to convenience and efficiency, and meeting them is helpful but not mandatory.

The first requirement is strategic. It is for system designers to focus on the specific problem to be solved and on the place where it resides within the educational system. The problem to be solved is to replace extremely non-versatile, expensive, heavy school books. The solution to this problem resides in the end-user device, and it requires nothing more than to replace the hard copy book with something functionally equivalent. The requirement does not encompass interactivity with a teacher for real-time instruction, or for corrections to work, or for anything else of that nature. An approach to this replacement with compelling advantages is to deploy a versatile, lightweight, affordable, electronic, book replacement device compatible with existing and future materials and delivery systems. Anything which goes beyond mere replacement of hard copy books adds cost that is not tied to solving the fundamental financial and health problems addressed here. No functions for implementing any capabilities beyond hard copy replacement are allocated to the BRD itself. That noted, any additional capabilities that may be able to be activated in the end-user device via the interface to a supra system are acceptable as long as any additional compatibility features required for such usage are of small scope and expense compared to budget constraints and are approved by a configuration control system.

The requirement for the BRD comprises a single electronic receiver-storage-display of moderate size and weight for each student. It performs the terminal distribution and display functions for a limitless number of hard copy text books. If nothing more is accomplished than merely successfully replacing textbooks with such devices, a massive improvement will nonetheless be achieved in both school finances and student health. Alternative embodiments and product-improved versions may ultimately provide playback of audio-visual products and other capabilities as well. All changes and additions must be subject to a disciplined configuration control process. Design screening must consider the marginal benefits of every change versus its marginal costs in acquisition and life cycle cost; damage susceptibility; increased theft attractiveness; delivery and user security and supra system interfaces; and supportability.

### Architectural and Information Security Aspects of the First Requirement

Architecturally, the book replacement device can be deployed in a highly secure network or in an entirely uncontrolled network. Onsite use in school systems' facilities represents the former situation. In such a scenario a single versatile device issued to each student for replacement of hard copy books is one element, the end-user element, in a distribution or content delivery system. The rest of the content delivery system is the supra system, and it exists now or is being deployed. The physical and functional demarcation points (the demarcs) between the BRD and the remainder of the system are clearly defined. Overall the content delivery systems including the book replacement device are encompassed within the school systems' command, control, communications, and computers (C4) infrastructure as a whole. This functionally includes resources outside the security gateways of the C4 system but reached through the school system's Internet service provider (ISP). The C4 system is somewhat synonymous with the information technology (IT) system, but it is actually more extensive.

Within each school systems' C4 infrastructure, the book replacement device will be the most numerous devices. Marginal costs which are minor in a single machine can be much more significant when aggregated over a whole school jurisdiction.

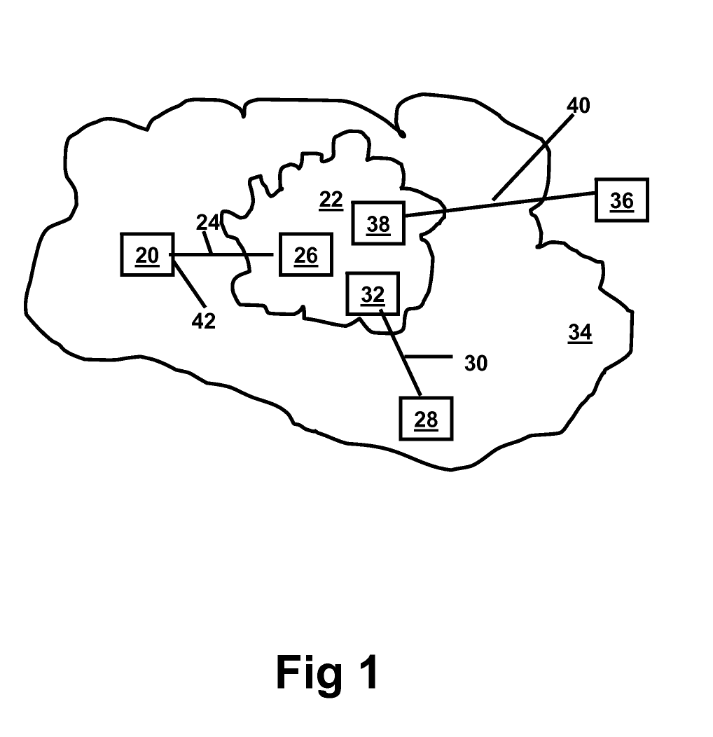

FIG. 1 depicts one of two nominal architectures, a highly secure system built around Ethernet local area networks (LAN). These are private networks not accessible to outsiders except through a firewall. Such a network also contains interfaces that lead to the Internet, but such interfaces are interior to internal and external gateways that can be closed at will by the school authorities. Security can be implemented via devices, circuits, and software in any or all of a number of places. It can be implemented within the BRD itself; at the attachment point for the cable which connects the book replacement device to the supra-system; within the cable itself; at the point where that cable itself is attached to the school C4 system; at a server to which all book replacement devices are connected; somewhere else; or all of the above. The only thing that will be consistent in a highly secure architecture is that the BRDs will not be exposed to or able to engage unfiltered materials unless all the gateways are set to allow it or have been bypassed.

FIG. 1 depicts the whole content delivery system. One book replacement device 20 is depicted as a peripheral to the school IT network 22. The portrayed BRD interfaces with the school network over an Ethernet local area network. It uses a wire, fiber-optic, or wireless interface medium 24 to connect to a server, router, switch, or other device 26. Another peripheral is a machine 28 containing a library data base. Machine 28 is interfaced to the C4 system via LAN medium 30 and device 32. All of these items are contained within the extended school system command, control, communications, and computers system 34. The C4 system 34 interfaces to the Internet via the school's Internet service provider 36. The school-ISP interface is by a gateway computer subsystem 38 employing a plurality of security devices and processes and the local loop 40 between the gateway subsystem and the ISP.

Within the C4 system the predominate cabling is unshielded twisted pair wire in categories 3, 4, 5, or 6 of the Telecommunications Information Association (TIA) standards for LAN cabling. These all have four pairs of wires in each cable. The connectors are registered jack 45s (RJ45). Telephone wire, which is TIA category 1 cable with only two wire pairs, is incompatible with LANs, as are the RJ11 connectors usually used with it. Other cabling that may be used in LANs is coaxial wire cable or fiber optic cable. Each has particular connectors. The local loop is usually metal or fiber optic cable, although there are a variety of alternative electronic implementations. The Public Switched Telephone Network (PSTN) is one implementation but not the only one. All these will evolve, and the BRD must be compatible with these and future interfaces and architectures.

Interface media and connections that may be used instead of a LAN to connect devices to C4 system 34 include standard serial and parallel circuits; universal serial bus (USB) linkages; the interface called IEEE 1394, also called FireWire and other commercial brand names; numerous wireless interfaces using radio frequency (RF), infrared (IR), and other electro-magnetic technologies; the interfaces that ultimately will succeed all of the aforementioned, and portable storage devices interfaced through any of these interface standards and used to provide physical transport of data. The specific interface is not critical. The interface ability to mate successfully and to provide adequate transmission capacity, speed, and security are critical. Such considerations are already fundamental to modern school IT system performance and security considerations.

As noted, book replacement device units will be the most numerous items within the extended school system IT network. In an elementary school with six grades of 60 students per grade there may be 360 book replacement devices active for the students alone at any time and a limited number of servers to support them. This is why it is so important to ensure no unnecessary costs creep into the individual units; given their numbers, the budgetary impact grows very quickly.

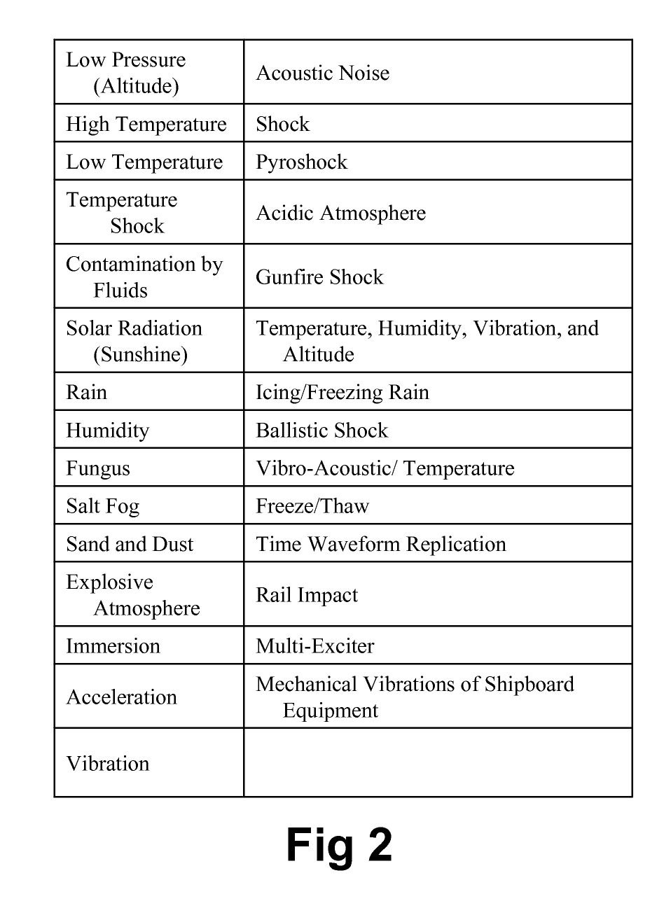

In FIG. 1 everything beyond the local interface device 26 but under school system control is either a control system of the network owner or a resource, at least in terms of its relationship to any end-user device connected to device 26. Threats exist as well, but they are generally outside the IT gateways. The point 42 in FIG. 2 represents the demarcation point (demarc) between the book replacement device and everything else in the school system. This demarc is congruent with and includes the sockets and antennae that provide the interfaces with the outside world, including the school LAN or equivalent. The sockets and antennae themselves are part of the BRD; anything attached to them is not within the book replacement device. The only aspect of the book replacement device that goes beyond the device itself is the interface configuration between it and the connecting medium to the local interface machine. This interface is controlled in an engineering specification that binds both sides of the interface with respect to physical attachment, signals, power, and environmental requirements including security. This interface is controlled by formal configuration control, and compatibility with this interface is part of the design requirements for the BRD. In some cases an adaptor may be interposed between the book replacement device and the local physical interface. In another case the security aspect can be implemented in the book replacement device itself in security devices, circuitry, and software. The demarc is where the three interfacing components, that is the physical attachment elements, the signals and power coming from the supra system, and the signals and power consumption coming from the book replacement device, must all be in pre-specified formats, magnitudes, phasing, timing, and configurations. Such interfaces typically will follow industry standards.

The alternative architecture has uncontrolled access. In this situation the book replacement device is plugged directly into the Internet or any other medium compatible with the interface ports. In this case the variety of web sites and storage devices which can be accessed is limited only by the degree of freedom provided by the built-in BRD controls and the discretion of the operator. Unlike the highly secure architecture of the school C4 system, an uncontrolled architecture requires the security controls to be part of the book replacement device itself. As with the highly controlled and secure architecture there are demarcs at the attachment points of the device to any connecting cables and at the BRD wireless antennae.

The successful book replacement device will be compatible with both architectures. That will allow students to use the device from their homes, plugging into the Internet as needed, as well as in school.

### Additional Book Replacement Device Requirements

The second requirement is that the book replacement device fully replaces the text book with respect to presentation detail, color, and readability. At least one major retailer of electronic textbooks states on their website that their electronic textbooks cannot be downloaded to their popular e-book readers. This is explicitly said to be because the latter are not capable of proper presentation of the materials.

The length, width, depth, and weight of the device must meet the display requirements of the book content without exceeding the strength and dexterity constraints of the users. Without being too bulky or too heavy they need powerful display capabilities. The displays must be sufficiently wide and high and offer fine enough detail to present maps and other graphics properly. This means that the conflicting parameters of field of view and resolution must be adequately met simultaneously, which may be done using magnification, given that all parameters affecting optical discrimination are being met and properly integrated. To ensure such a result the ultimate requirements in presentation performance, user characteristics, and ambient conditions must be specified, and they must form the basis for the trade studies that will determine the right equipment with which to populate the system.

In this usage the term resolution takes the optical definition of an angular measurement related to visual acuity. It does not refer to the display product descriptor related to the vintage of a liquid crystal display (LCD) and its static performance under arbitrarily defined conditions.

It is absolutely unacceptable to rely on commercial suppliers to deliver the performance needed for the BRD on their own. A recent news story reported a new medical problem directly resulting from a lack of proper engineering in this area. Users of handheld displays like texting devices have reported eye strain and headaches due to having to hold their units too close to their faces in order to read the small text. They could, of course, set the text size larger, but then they would not get enough text on the screen at a time. In this case they had a small field of view available so they compensated first by using tiny font to get adequate data density on the screen and then by holding the screen close enough to be able to read it. Unfortunately their eyes were not engineered for such conditions, and pain and vision problems ensued. This is exactly the kind of man-machine interface problem to avoid in a text book replacement device, and that is why formal requirements for its development are a necessity. It is not enough to rely on static, nominal performance descriptors with regard to providing the ultimate performance. Nor is it wise policy to assume commercial suppliers will think these issues through and get it right on their own straight out of the box, such fact being confirmed by the newly identified medical problem cited here.

The third requirement is that the book replacement devices are inherently highly resistant to damage by routine mishandling and common accidents. The fourth and fifth, respectively, are that the BRDs are inherently extremely theft-resistant and that they provide safe operations both for their users and for the owners of the assets. The latter is a multi-faceted requirement. The system must protect the download source and downloaded assets from unauthorized access. It must also protect the user and the book replacement device itself from malicious tampering and from accidental corruption both in the download and in the storage phases. The tasks and processes for providing such security are met within the disciplines and practices of information security (IS), information assurance (IA), and file verification.

The last requirement for the book replacement device is that it is affordable in its purchase price and over the life cycle. Life cycle costs (LCC) in this usage encompass all costs from the procurement, deployment, storage, operation, updating, repair, servicing, and disposal of the respective systems. An inherent feature of a cost-effective device is that it be supportable in all aspects of maintenance of the hardware and software. All the LCC cost elements for hard copy books may be very different from those of electronic books and may be higher or lower. Compared to non-versatile text books which must be routinely replaced, major life cycle cost advantages are inherent with very versatile machines which continue to work after normal accidents and which are virtually never stolen, given that industry does know how to make such machines relatively inexpensively. As the most numerous element of the school C4 system, the guiding principle for configuration control of the book replacement device can be succinctly stated, “Better is the enemy of good enough.”

The four lesser requirements are features to enhance the efficiency of the implementation. The first is that the book replacement devices can be quickly and easily identified as to which school owns it. The second is that it should be inherently resistant to being lost. The third is that it should enhance inventory and other logistics functions. The fourth is that it be inherently hard for students to forget to bring them with them going to or from school or elsewhere in their daily agendas. These features reduce the life cycle costs and enhance the affordability. They are not essential.

To summarize, the book replacement device has a very narrow mission: to replace hard copy textbooks and references in the immediate future. Ultimately it may replace other support systems and devices whose functions can be practicably encompassed. Within that limited mission the BRD is of unlimited versatility, being envisioned as loading, storing, and displaying anything that meets the industry-standard interface requirements. To be developed and deployed successfully, the book replacement device has specific system design requirements which are essential and definitive as follows:
Focus on and create requirements for an end-user device, a machine that at the least is capable of replacing as many separate types and titles of hard copy textbooks and reference books as practicable under system constraints and configuration control, including architectural constraints, whether deployed as a separate product or as a separately deliverable configuration item within a delivery system product
Provide presentation equal to or better than hard copy books
Be highly resistant to accidental damage such as characterizes school children's usage
Be highly theft-resistant inherently
Provide protection of the source, data, receiver, and user from malicious or accidental events during the downloading, presentation, and storage of the data and maintenance of the machines
Be as affordable or more affordable than hard copy books in acquisition and life cycle costs

Note that meeting or at least addressing these requirements is the key. If a BRD is painted red and gold to match a school's colors, it provides a theft resistance feature whether that was the primary purpose or not. On the other hand, if the use of file verification is considered but decided against in the trade studies, that satisfies the requirement to consider it as a potential IA feature.

### Existing Standards and Methods To Support Required Development

Design and industrial standards do exist to plan, organize, characterize, and confirm the suitability of designs in most dimensions of the requirements. Some design solutions meet several requirements. Practices are well established and documented on how to plan and organize a development project, how to provide the appearance and readability of standard textbooks, how to provide necessary ruggedness and safety characteristics in electronic devices, and how to achieve the necessary security of electronic systems against manipulation and penetration. Acquisition and life cycle costs are well understood aspects of affordability and of system logistics, although actual decision-making in these areas frequently has a large, subjective component.

Planning and organizing product development is extremely well documented in the systems development and life cycle support doctrines of the U.S. military. The references encompass all phases of the development from prior to the documentation of requirements to the modernization or disposal of obsolescent systems. A new system starts with formalized requirements. Ultimately two packages will fully define a system. These are the Manufacturing Data Package (MDP) and the Logistics Support Plan (LSP) and subordinate logistics products. The MDP itself has three parts: the Product Specification, the Process Specification, and the Material Specification. Collectively they define what the system is and what it can do; what do you make it from; how do you make it; and how do you operate and support it. All such functions and practices are implemented to different degrees in engineering companies world-wide.

With regard to planning and organization several publications are particularly helpful. The first will be covered in some depth in later paragraphs. It is U.S. Military Standard 810, Department of Defense Test Method Standard, Environmental Engineering Considerations and Laboratory Tests. The current version of the document is G, and the abbreviated designation is MIL-STD-810G. This document has been developed over the course of decades to ensure that American military equipment can perform its function throughout all the variations it may see in environmental and combat stress. It is an excellent baseline reference for understanding what is available and how to use it.

MIL-STD-810G has two primary parts and a third part of no interest to this discussion. The first part describes the engineering and engineering management processes for, among other things, tailoring an environmental specification and creating a test plan. The second part will be of interest in a paragraph to follow shortly.

Another useful reference is U.S. Military Handbook 881, Department of Defense Handbook Work Breakdown Structures for Defense Materiel Items, MIL-HDBK-881. The current version is MIL-HDBK-881A. MIL-HDBK-881A tells how to plan and organize product development when the end item is an integrated and harmonized system of separately developed subsystems.

### Other Useful References Cover Configuration Control and Other Aspects.

Standards and techniques for providing adequate readability for e-books are found in textbooks and industry standards such as International Standards Organization (ISO) Document 9241, Visual Display Terminals (VDTs) Used for Office Tasks—Ergonomic Requirements. The Society for Information Display, or SID, is a large international professional society dedicated to advancing the state of the art in displays and monitors and to fostering mastery of the relevant principles and techniques. The required techniques for full readability are widely understood and are fully realized in numerous countries in design, production, and support.

Standards for ruggedness and safety have several axes. First, the ability of a device to resist damage can be defined and objectively demonstrated using appropriate existing standards. It is important, though, to recognize differences in the scope, depth, authority, and usage among the alternate existing standards. The reason it is important is because the authority and credibility of these standards and their tests will be critical to providing assurance for purchasing authorities, people who otherwise must be skeptical of the wisdom of issuing portable electronic devices into the hands of school children. The fact that a rigorous, recognized standard has been used for testing such a device against such a usage may be more important than the final choice of which specific standard to use.

The oldest and most all-encompassing of these standards is the U.S. Military Standard 810 identified earlier. It is the second part of MIL-STD-810G that is of most interest in this connection. It addresses in great depth a total of 29 different environmental conditions and combinations of conditions. It explains what the terms mean, what kind of damage the conditions can do to different types of materials, and how they can affect the use of a system. It also describes detailed test apparatuses and the test procedures to follow to ensure the specific requirements with regard to the selected conditions have been met. The specific conditions are listed in FIG. 2.

The sections for each phenomenon identify what the circumstances are for which the condition might be encountered. They are comprehensive to a degree beyond the imagination of most people. For example, to define testing for the effects of low pressure due to unprotected exposure to high altitude MIL-STD-810 G specifies different procedures for four different circumstances. These are (1) storage or operation at high ground elevation, specifically up to 15,000 feet above sea level; (2) transport in aircraft; (3) subjection to rapid or explosive decompression; and (4) external carriage on an aircraft. In a similar vein the test procedures themselves can be extraordinarily exacting and protracted. A concise example of this is the summarized procedure for testing for fungus damage resistance, as follows:
Fungus damage resistance tests are performed by inoculation of test items with strains of any or all of 5 standard species or others as selected. The application and test are performed by qualified microbiologists due to the inherent danger of some test strains and to possible ambiguity in identifying the cultures that ultimately develop. Test conditions are with temperature from 84 to 88 degrees F. and humidity from 90% to 99% for durations to 84 days.

Clearly the school book replacement device development has need of only a very small portion of MIL-STD-810. The first use for the Standard is to identify the conditions to incorporate into the BRD requirements document. After all, MIL-STD-810 does fully circumscribe the possibilities. Of the 29 conditions covered only four will usually apply to a device carried to and from school by a student and operated in a controlled classroom or other benign environment. These are rain, sand and dust, immersion, and shock. To fully accommodate these four conditions and their nuances with regard to students' handling practices MIL-STD-810 also helps determine how to tailor the testing of any specific design at appropriately reduced stress levels while still providing adequate product assurance. For example the drop distance in shock testing for a book replacement device will be a fraction of that specified for testing a guided missile transport container. Finally, MIL-STD-810 also provides an invaluable benchmark for manufacturers to present their school district customers with what has been firmly and authoritatively established.

Given the range of environmental hazards identified for the book replacement device, it is useful to consider some of the ways of dealing with them. Hardening against shock and the intrusion of water and dust has numerous options well understood in industry. The use of heavier or stiffer materials or, alternatively, more flexible materials, can be combined with padding and shock mounting materials such as rubber grommets and rubber gaskets. Additional environmental performance can be gained by sealing with glue, caulk, and gaskets and by using lock washers, cotter pins, and thread cement to prevent screws from backing out. Structural details like arches, arched supports, flanges, reinforcing shapes like triangular and box structures, and the use of multi-layered reinforcements all provide strength and rigidity with reduced mass. In the aircraft industry multi-layered structural reinforcement designs are sometimes called doublers and triplers. Reinforced structures can be formed as a single piece or assembled from pieces.

A common technique for protecting displays is to cover them with a glass plate. Sometimes an LCD will be bonded with heavy adhesive to a sheet of glass, and this provides excellent protection against flexure and impact damage. Frontal glass covering a display may be coated with various filter films and materials for optical or mechanical protection such as anti-scratch filters, but care must be taken to ensure adequate transmissivity is maintained. Where water ingress cannot be prevented with complete confidence a coating of a water proof material like a varnish may be applied over circuitry. Hardening techniques such as these have been proven in defense display systems where LCD-configured displays have been proven to withstand 60 g's of shock and more using industry standard hammer tests and underwater explosives tests.

There is another very important set of standards, and it provides an alternative to MIL-STD-810. These are the standards of the International Electrotechnical Commission (IEC). The IEC is an international standards agency based in Europe. It has two standards of particular interest in hardening that complement MIL-STD-810G with respect to two critical areas. These are IEC 60529, Degrees of Protection Provided by Enclosures (IP Code), and IEC 62262, Degrees of Protection Provided by Enclosures for Electrical Equipment Against External Mechanical Impacts (IK Code).

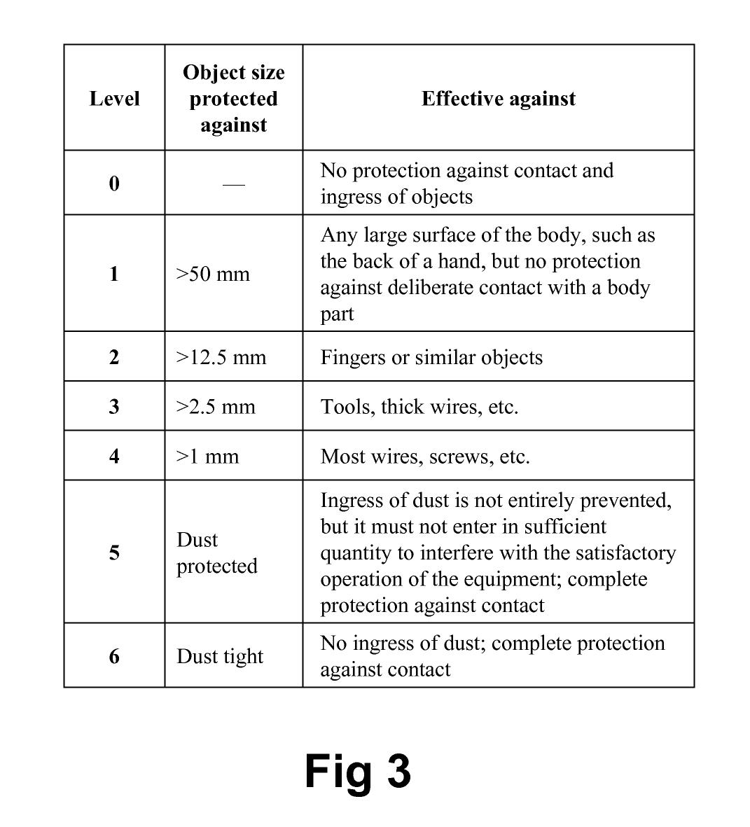

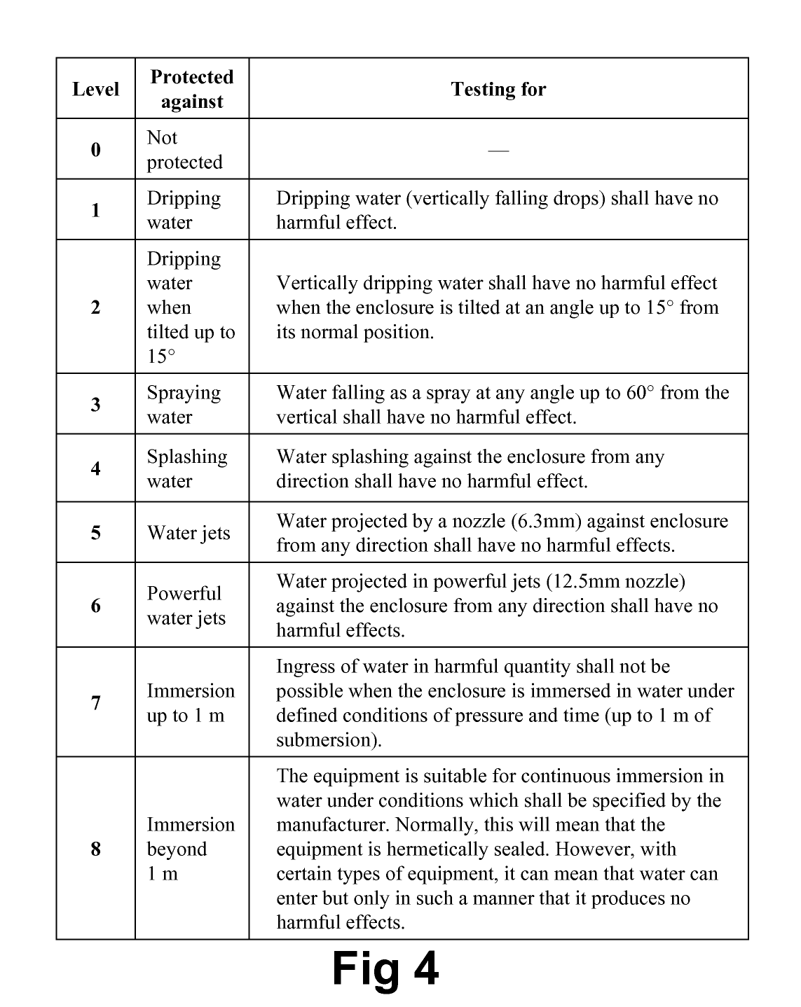

IEC 60529 defines two-digit codes to characterize the degrees of protection an enclosure of electrical materials provides against intrusion by solid objects and liquids. It also prescribes test methods to confirm that the level of protection claimed is in fact delivered. The solids range in size from objects as large as the back of the hand down to particles of dust. FIG. 3 provides the table of codes and the corresponding values for protection against solids. FIG. 4 provides the table for protection against liquids.

An IP rating of 11 from the table for solids would indicate very limited and weak protection, specifically only enough to prevent the entry of a large object like the back of the hand. For liquids an IP rating of 11 would indicate protection against vertically dripping water. An IP of 68 in each table, on the other hand, would mean neither dust nor water can enter even when immersed, except as noted. The former rating would therefore signify a light duty structure and the latter an extremely tight and protective enclosure.

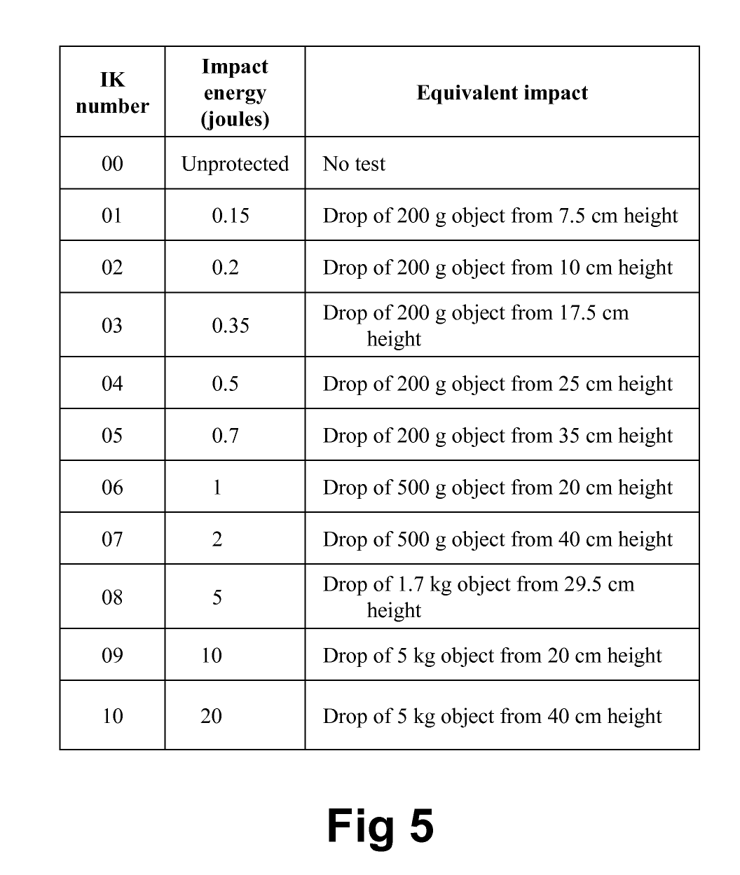

IEC 62262 defines 11 codes for different levels of protection provided to an electrical device against external mechanical impacts. Level IK00 is unprotected. The others range from IK01 to IK10, and the impact energy levels that correspond to these levels of protection range from 0.15 to 20 joules. The impacts that correspond to these energy levels are shown in FIG. 5.

IEC 62262 also provides detailed test apparatuses and procedures to confirm that devices meet the level of protection claimed for them. All the IK tests involve slamming a hammer of specified characteristics into a representative test article at different controlled speeds. MIL-STD-810 and the IEC standards cited are the main references which are applicable, although they are not the only ones in existence. The United Kingdom has a set of standards for military materials similar to the American Military Standards. They are called the Defense Standards or DEF STAN. They are not as widely used in industry as the U.S. standards. There are two commercial alternatives to the IEC standards for characterizing ruggedness in electrical devices. The first is the National Electrical Manufacturers Association (NEMA) classification system. The second is the system used for the assignment, or rejection, of ratings as “intrinsically safe” (I-Safe). The NEMA system is sometimes called NEMA 250.

Neither the NEMA nor the I-SAFE systems is of value in characterizing school book replacement devices. The NEMA ratings are generally for non-portable equipment. The I-Safe ratings are for devices to be used in hazardous conditions; they indicate how well the device can avoid causing various types of explosive atmospheres to explode. The design requirements for book replacement devices do not foresee school children reading textbooks in any such an atmosphere, so the I-SAFE ratings are not applicable to text book replacement devices. The I-SAFE rating is appropriate, however, for reference BRDs that are used in potentially explosive environments.

Another standard associated with electronic devices that is not directly relevant to this invention is EPEAT. EPEAT is a registry of companies whose products have met and continue to meet a wide variety of requirements with respect to having a minimal impact on the planet. The EPEAT criteria are encompassed in eight categories as follows:
Reduction/elimination of environmentally sensitive materials
Materials selection
Design for end of life
Product longevity/life cycle extension
Energy conservation
End of life management
Corporate performance
Packaging

While manufacturers of specific implementations of the invention will probably include EPEAT in their design analyses, none of the criteria affects the requirements for the book replacement devices described herein per se except with respect to cost and affordability.

Thus, two different sets of internationally recognized standards do exist and are applicable to book replacement devices engineering. They are MIL-STD-810 and the IEC standards. Either is fully acceptable to support authoritative testing and documentation of the hardness of the book replacement devices.

### Theft Resistance Features, Methods, and Practices

There is no standard for making a portable electronic device theft-proof, but there are two intrinsic characteristics that can have that effect. The first is to make mere possession of the item conspicuously and inherently suspicious except for people readily identifiable as authorized custodians. The second is to make the selling price of the stolen object very low. When both these things have been done, there won't be any market for the items when stolen because the profit to the felonious reseller is not worth the risk.

The features needed to achieve the first condition are anything that provides a visually conspicuous and unique appearance. An unusual shape, an unusual color, an unusual material, and physical markings such as engravings can provide such an effect separately or together. This effect obtains whether the conspicuous feature has a primary mission of security or is a marketing enhancement like a special paint scheme. For example, if all the BRDs in a school district were painted in removal-resistant bright red and yellow to match the colors of the county flag, that characteristic would certainly make them easy to differentiate at a glance from standardized e-readers of any size.

The way to provide the second condition, a low selling price for a stolen device, has to be accomplished at both the assembly level and at the piece parts level. One way to reduce its resale as an assembly is to make the object extremely non-versatile for anything of interest to buyers of stolen goods. Applied to the instant problem, in the near term the BRD would have utility for virtually nothing other than as a school textbook replacement device. A device that can do little except be a school book will not be an attractive theft target for resale as an assembly.

The other aspect, to make it undesirable as an assembly to be stripped down for its component parts, is less obvious. It requires that none of the parts is separately an inherently, significantly valuable item. The way to do that is for one design requirement to be that its component parts are relatively low performance and pedestrian in nature when compared to the current state of the art. This does not mean they have to be obsolete or even nearly so. It just requires that they be back from the cutting edge. That said, if the other anti-theft have been implemented, this particular step constitutes an optional, further strengthening measure for the theft resistance rather than a necessity.

If both of these conditions, a lack of versatility at the top level and a lack of cutting edge parts at the lower levels, are achieved in the design, the book replacement device will have little value in criminal resale either as an assembled unit or broken up for parts.

Having defined the two general axes for advance, the next step then is to identify how to limit functional versatility without impeding performance of the mission. Versatility is a multi-dimensional parameter. Limiting versatility can be accomplished in three places: in the functions in the requirements, in the controls that can be reached by the operators, and in the software, and these overlap somewhat.

An example of functional limiting as a security measure would be to specify that the requirement is only to present the visual content of an electronic version of a hard copy textbook. If the developer sticks to this requirement, there will be no audio capability, and the display will not be designed to accommodate moving pictures. This would automatically eliminate the use for playing DVD movies and music. In most cases the lack of audio-visual playback in a book is not an impediment to legitimate instruction, so this is a generally attractive potential approach.

There are negative aspects, however, to this constraint. Not providing audio playback negatively impacts the use for language instruction, given that one aspect of language instruction is aural presentation of vocabulary and phrases. This is not a small issue. The world is increasingly integrated, and language books are not something to be excluded from a universal design. So perhaps the approach is to specify a relatively low fidelity audio system, one that would be understandable for language trainers but not good enough to play entertainment music in a lively or exciting manner. Since there are already better-sounding and much more compact products for music listeners at low prices than a stolen BRD would be, adding clear but low fidelity playback would not make the book replacement device any more attractive as a theft target.

Another negative aspect of preventing entertainment DVD-watching by not supporting moving video would be to block the device from playing educational videos. Unfortunately, if the device can play videos, this positive feature which increases the versatility of the machine as an educational tool also reduces the inherent theft resistance. This illustrates a standing internal conflict for the design requirements: educational utility versus theft resistance. The solution is to monitor the evolving technology. As the market price for legal alternatives for providing any desired function goes down, those capabilities can be safely added to the book replacement devices without a decrease in the theft resistance. Proper configuration control will allow the device to evolve.

In similar fashion the specification for the control keys limits whether the device can be used for something other than intended. No task or action can be done on any machine that cannot be selected via the available controls. If the operator inputs needed to do something outside the legitimate mission are not accessible, the operator will be unable to do the unauthorized activities. This continues to be true when touch screen controls are used to the extent that the book replacement device software is limited to the desired functions and is protected against unauthorized modifications.

Control of the software in fact is an exceptionally powerful way to achieve the desired restrictions. If the operating system and the selected applications do not allow any operations or control selections not consistent with the intended mission, and if neither type of software can be changed except by properly authenticated people or systems, then there will be no diversion from the original mission. If nothing can be downloaded except from an authorized source, and especially if nothing can be downloaded or played that does not authenticate itself as an authorized download, the device is useless for anything else.

Whether implemented in software or physical devices or a combination of the two, there is one inexpensive feature that would dramatically improve the theft-resistance and the content delivery security of the handheld libraries. That would be to make the device able to only download from specific Internet universal resource locators (URL), and from sources authenticated as authorized. For example, the book replacement devices could use public key encryption or some other technical approach to recognize sources to which it is connected through an Ethernet circuit or via a USB, IEEE 1394, or other port. If students can go straight onto the Internet and be able to only access authorized safe sites, diversion from the official usage is effectively prevented, and both the device and the user of the device are automatically safer.

### Ancillary Electronic Security Systems

A completely different functional approach to achieving reduced losses due to theft is to install software and other features that make it easy for police to locate a stolen device by backtracking it after the theft. Backtrack-supporting software is installed in a computer either in the hard drive or in a separate chip. Every time a computer so equipped is turned on, the software automatically queries the company's home site to check the computer's status. If the owner has reported it stolen, the software automatically starts a series of transmissions that can be reverse-tracked to the unauthorized user's physical location. The best known of these is Lojack® for Laptops.

Another electronic system useful in security and control is the radio frequency identification device system, also called RFID. An RFID system includes an electronic device called a tag that can be affixed to an object and then directed by a radio signal to perform a limited set of tasks. One of these tasks is frequently to send a message back to the querying transmitter system. Usually the signal is in the ultra high frequency band, UHF. Depending on the device itself, the RFID tag can be programmed to send simple information such as the serial number of the container in which it is riding, or it can perform more complicated tasks. One example of the latter is to download and send dynamically changing information read from sensors to which it is attached. RFID chips can be powered to operate and to transmit their response to a query in several ways. Power can be supplied by the command signal they receive or by a battery, or they can use a battery only for the operations other than transmitting. They can also be read-only or read-write.

Putting RFID antennas at every access and departure channel for a store room or new vehicle lot can facilitate automatic inventory control. RFIDs can be very helpful for reducing theft. The tag can be programmed to trigger an alarm if it travels across a demarcation point or if it is impinged by search signals from a portable interrogator carried by a searcher.

RFID systems have limitations due to range, weather, the specific functions and design of the tag used, and whether the device is installed so that it is exposed to transmissions or shielded behind materials such as metal that can block transmissions. There are also viruses and other malware in the environment that can attack RFIDs.

For book replacement devices as a product RFIDs would be less useful for theft resistance than for inventory management and other logistics support. They could also be designed to interface with a boundary system at each student's home. The boundary system could be programmed to ensure that at specified times as the students cross the boundary system threshold heading for their bus their BRD is going with them. That could help keep students from forgetting them. Such a system might entail installing a matching tag on each student's watch, eye glasses, or other ritually-carried object to trigger the RFID system to look for a matching signal from the BRD. School busses could be configured to perform a similar query for embarking students and then to send a message to the school of which students have forgotten their books. This would allow schools to call the parents to have them bring the machine to school or for spare BRDs to be pre-staged in their classrooms. For forgetful people the RFID could be triggered to initiate an aural signal like an alarm to indicate where it is if they have misplaced it. This would also facilitate police searches for stolen hardware if such became necessary.

Another useful identification technique is bar coding. Bar coding allows the serial number or other identification to be placed on an object and to later be picked up by scanners waved over it. Bar coding is so economical and reliable it is the main way groceries are checked out now. Bar coding on the book replacement device in addition to using RFIDs provides a very inexpensive alternative approach for accelerated inventories with more accurate results.

### Design Aspects of Applicable Information Assurance

The mandatory requirements for secure delivery and post-delivery storage for book replacement devices are standard aspects of information assurance as follows:
Only an authorized person can access the source and download materials.
The person seeking the download connects only with authorized sources.
The materials that enter the machine accepting the download consist only of the authorized data.
The materials downloaded enter local storage uncorrupted and exactly matching the source file, and any degradation in storage will be detected.

Another requirement of IA, availability of the data, is less a hard requirement for the book replacement device than the other four. That is because downloading to the BRD is not expected to be a frequent activity, and it is expected to be generally foreseeable. Students or librarians should be able to do it any time during the school or work day. If Internet access is one of the channels, downloading should be possible on all days and at all hours. That noted, availability could become an issue if security measures were made too restrictive or if the feed channels lacked sufficient bandwidth for the user demand.

The first of the four IA requirements exists to protect the stored data assets. The other three protect the operator seeking the download or others who may use it later. Meeting each of the four requirements involves actions by the book replacement device and other actions by the source. By virtue of being on the other side of the demarc from the BRD the source is part of the extended supra system. Thus an interface compatibility requirement arises to allow each side to perform coordinated IA. This affects the book replacement device only to the extent that it influences the specification for the compatible interface.

The criticality of the accuracy of the data to be downloaded will have an effect on the measures selected to ensure information assurance. A very small number of errors in a text is probably acceptable. On the other hand, some reference data must be absolutely reliable in its accuracy. Examples of this latter situation are when it is used for controlling complex chemical processes and other exacting specifications where even single errors can produce catastrophic results. Therefore the expense that is justified in the IA measures for the two types of data will differ proportionately.

The first requirement of the four IA requirements is met by authentication of the download applicant. Authentication can be done based on who someone is, by what they have, or by what they know. These are implemented in biometric identification systems like finger prints, by the possession and use of special physical keys, and by the entry of passwords. The first step in the process is taken by the book replacement device in requesting to connect with the target source. The second action is by the source, which must challenge the applicant. The third is for the user to provide his/her electronic credentials within the prescribed time, and the last is for the source to allow the connection.

A powerful authentication approach exists which can greatly simplify operations in networks with multiple successive barriers to access that must be crossed in order. Normally in such a case a user has to authenticate him- or herself each time to pass each check point. Single sign-on is a method whereby a user authenticates him- or herself once, and at each station thereafter the security system automatically provides authentication. For a book replacement reader this could automate everything after the initial sign in of the user. Once logged in properly the user could select a book or other object to view, and the machine would automatically do the rest. It would select the source, make any connections necessary, authenticate the download source, authenticate the user for the download, perform and verify the download, and present or store the material.

Normally there is a major security issue with single sign on because it opens so many doors once accepted. At the very least a periodic query of the user is normally made to ensure that the access should not be terminated. This is sometimes called a keep-alive query. In the case of the school book replacement all the downstream functions after single sign-on has been accomplished would have such severely proscribed options that the possible consequences of a compromise would not be considerable. The single sign-on for the BRD might be limited to the time from authentication immediately after a download command has been inputted until there are no more immediate downloads. At that point the access could be withdrawn.

The second requirement, exclusion of unauthorized sources, can be met in three ways. The first is by using public key encryption to confirm the identity of the source at the time of the connection. This is strengthened if a mandatory block against the connection will ensue if the site engaged has any deficiency with its public key infrastructure (PKI) certificate, or if authentication fails for any other reason. Any company doing business that involves taking orders over the Internet will have a current certificate. Other organizations such as school systems can obtain certificates as well. Trusted authority certificates that allow an individual's computer to recognize a valid certificate are typically part of the software installed on his/her computer. Such trusted authority certificates are periodically updated to ensure currency. Thus before engaging a web site the user can confirm it is who it claims it is.

The second way is to limit the URLs that a book replacement device can select as a target, as previously noted. The third is the ability of the system administrator to place blocks on the external ports and antennae to prevent an interface from being established across them. It is common, for example, for computers being used with sensitive materials to have all their USB ports blocked physically or electronically. These three source control approaches can make it highly unlikely that the wrong source will be accessed or that a malicious agent can spoof the user into erroneously downloading bad material.

The third and fourth requirements of IA can be met by using file verification software. This software takes the streams of 1s and 0s that are the binary number equivalents of the reference book content, divides the streams into groups, and performs an algorithm on the groups that returns a relatively short number for the file as a whole. The specified algorithm always returns the same number for the file as long as no letter, number, space, or character has changed. Such numbers are sometimes called checksums and sometimes hashes. There are several other names, but some of these other names have nuances that limit their applicability when used in their exact meaning.

After the algorithm has determined the hash for the item to be downloaded, or it has been retrieved from a record, the value is sent from the source to the downloader either by an out-of-band channel or in an encrypted form. Alternatively it can be appended as part of a digital signature to the material downloaded. Once the downloader's machine possesses the hash it can run the algorithm on the download. If anything has changed in the entire book for any reason, the algorithm will return a different number, and the file will be identified as corrupted. These hashes can also find evidence of tampering because such will make the checksum different. Some can find hidden malware like viruses and Trojans. Since the capabilities of the different suites of file verification software vary, selection of the proper one is fundamental. One of the beauties of possessing the hash for a download is that for as long as the book is in onboard storage the hash can be re-run as frequently as desired to ensure the file has not been corrupted. The third and fourth of the four IA requirements are also supported by the periodic use of anti-virus and Internet security software.

### Design Aspects of Affordability

Affordability pertains to the initial cost of items acquired and their life cycle cost. It includes generally the acquisition cost, the deployment cost, the operation and support cost, and the cost of modernization or disposal. Specific expense elements include but are not limited to training for operators and maintainers; maintenance parts, labor, and repair equipment; modifications to the operator's buildings and facilities themselves that might be needed to support use of the devices; storage and inventory management; modernization to keep it at the desired performance standard as the standard itself evolves or to adapt the device when repair parts go out of production; and disposal. Life cycle cost and the design implications of it are well understood in industry because makers of vehicles, major tools, and facilities routinely include such considerations in their design and customer support processes. Even for relatively low technology tools such as home vacuum cleaners there is a need to plan for replacement dust catcher bags, drive belts, beater bars, and filters and for the overhaul of the electrical motors and other repairable components. Moreover, since every system developed for the U.S. military undergoes exacting management of all the life cycle cost components and their design drivers, the processes are extremely well documented. Further they enjoy exceptional lessons-learned resources and a work force of numerous skilled technical support personnel.

### Prior Art

### Related Patents

Related patents can be grouped into four groups. The first collects those patents that primarily apply at the architecture level of the school systems' supra-systems and above. They distribute digital content into the demarc and may or may not involve interactivity. The second includes those patents that do involve terminal electronic books but are primarily defined by real-time, full interoperability between them and the higher level system. The third group includes inventions that apply to subsystems or sub-subsystems of the BRD. They disclose potential enhancements and features to be considered for development in specific BRD products. They do not constitute or apply to specific requirements for the BRD, nor do they apply to the BRD at the tier 1 system level. The last group contains inventions which are electronic book variants but nonetheless have significant points of incongruity with the book replacement device.

Nine Patents Apply to the Architecture Above the Electronic Book.

This includes the schools' C4 IT supra-system and other networks. These are U.S. Pat. Nos. 5,809,247; 6,009,429; 7,359,944; 7,403,924; 7,830,830; 7,831,240; 7,831,512; 7,831,663; and 7,831,757.

U.S. Pat. Nos. 5,809,247 (1998) by Richardson et al and 6,009,429 (1999) by Greer et al provide inventions for enhanced use of the World Wide Web. The former describes an approach for facilitated web touring to allow more efficient web searching and online research. The latter discloses a way to package into predetermined sequences a number of otherwise separate web sites, such packages being selectable and enterable via specific starting point web sites. These both constitute content packaging for delivery, which is a task addressed at the supra system level entirely on the other side of the demarc from the BRD.

In U.S. Pat. No. 7,359,944 An (2008) describes a new type of online transaction, the providing of copyrighted or otherwise protected digital content to requestors in exchange for the requestors agreeing to watch specific advertisements. This is a distribution system, not an electronic book. The electronic book connection is that such is a tool to implement the distribution. This has almost no points of congruity with the BRD except that it pertains to digital content and to a distribution system for such. The purpose and details do not intersect with the BRD.

U.S. Pat. No. 7,403,924 by Sakamura et al (2008) describes a system to implement selling, buying, and delivering digitized books and parts thereof with encryption and decryption and to support secure billing and payment processes. The electronic book connection is as the tool to conduct specific transactions which are related to content delivery in a secure manner. It says almost nothing about the terminal device not directly related to the ordering, the decryption and secure operations, and the payments steps. The physical details are not addressed nor the specific interfaces except to note that the transactions are Internet-related. Otherwise none of the six requirements of the BRD is addressed.

In U.S. Pat. No. 7,830,830 (2010) Chan discloses a system that utilizes functional partitioning and allocation of transmission channels to minimize throughput and local processing requirements for distributing data. The objective is to minimize cost for news companies while distributing individual news stories according to each story's specific need for urgency. The main sorting distribution is by specialized machines and broadcast techniques, while inquiries would use bi-directional channels. This invention applies at the supra system as a distribution approach with a significant inter-level interactivity component. The BRD, on the other hand, features on-demand downloads without any user interaction with the transmitting facility beyond selecting and managing the download conditions.

In U.S. Pat. No. 7,831,240 (2010) Patron et al describe a system for storing customer information in a centralized location to facilitate commerce, particularly wireless account service. This is of particular value to support inter-company billing for cell phone usage while roaming. The BRD utilization has no elements which intersect such a pattern. BRD utilization is either within the school system's own LANs or by direct connection to the Internet and thereafter to a remote data source. The former precludes any need for the opportunities presented by this invention. The latter will virtually always be done from home, from a friend's home, or for traveling students, from the home visited or a hotel. All these points of access offer an online interface that is not separately billed for or that typically is included in the bill for the lodging. This patent has no application to the BRD at any level of the architecture.

In U.S. Pat. No. 7,831,512 (2010) Akadiri discloses an electronic marketplace for digital content including television, web pages, and others. The marketplace matches unmet requirements from primary content providers to available supplies from secondary content providers. This is a distribution system that might act at the supra system level but not on the BRD side of the demarc.

U.S. Pat. No. 7,831,663 (2010) by Ludwig et al describes a system to adapt desktop computers to enable distributed conferencing at a greatly improved level of performance. A distributed conference is defined in the patent as a conference among people not collocated. In the invention of U.S. Pat. No. 7,831,663 the conferees use teleconferencing and remote video and audio manipulation so as to achieve many of the nuances of face-to-face conferencing. The apparatus of U.S. Pat. No. 7,831,663 involves teleconferencing; a wide area network (WAN) with client devices and storage devices containing multimedia documents; and capabilities whereby remote users can access and modify the remotely stored files and see the results of the changes. This invention is intended to allow users to remotely change stored data and to support live interaction between remotely located parties. Both of these exceed simple download the requirements of the BRD. As a content delivery approach it may apply to the supra-system, but not to a terminal device for replacing books.

In U.S. Pat. No. 7,831,757 (2010) Habuto et al disclose a system to use an intermediate cradle device to facilitate downloading of digital content between a source and a portable computer. It is like establishing a holding cache for downloaded material allowing final delivery later. It is intended to make downloading easier, especially for users away from home or office. This invention is a distribution facilitator and operates entirely on the supra system side of the demarc. It has nothing to do with the BRD per se. Furthermore, with their existing data libraries school systems' C4 systems will have little use for it either. Similarly reference book replacement devices will probably tap into non-portable sources that do not need such caches either.

Six Patents Apply Inextricably to Both Sides of the Demarc.

Their identity monolithically encompasses both the supra-system and the terminal electronic stations inseparably. They all feature interactive communications, three of them for real-time teaching systems. References to end-user electronic book devices are primarily in regard to how they support the supra system. These include U.S. Pat. Nos. 5,176,520; 5,263,869; 6,549,751; 6,712,701; 6,895,393; and 7,124,100.

In U.S. Pat. No. 5,176,520 (1993) Hamilton describes a fully interactive system where an instructor with a computer at one desk and a student with a computer at another desk can share an electronic sheet of paper, and several students each with his or her own computer at different desks can be managed at a time. Each member of a teacher-student pair is able to write on an image shown on their monitor, and this image is shared between the two stations so that they can interact on the image involved. This invention is a supra-system level invention with interactivity between the teacher and each of the students as a fundamental feature. This is completely outside the fundamental book replacement requirement. The mission, sophistication, functional allocation, and cost of even the simplest of such systems do not align at all with the requirements for the book replacement device.

That noted, the book replacement device is not inherently incompatible with the concept of U.S. Pat. No. 5,176,520. To implement the concept of U.S. Pat. No. 5,176,520 with the book replacement device none of the functionality for the interactivity would reside in the book replacement device itself but somewhere in the supra system. Such capability could certainly be added to the schools' or libraries' IT systems, but that does not give it any part of the book replacement device. That is unless such is done at some time in the future when the marginal cost for adding the capabilities to the hard copy book replacement device has become vanishingly small. Even then the added functionality would be a marginal capability authorized under strict configuration control rather than a defining feature of the book replacement devices.

In U.S. Pat. No. 5,263,869 (1993) Ziv-El describes a system functionally similar to Hamilton's except in some specifics of the implementation. The same characteristics that prevent Hamilton's invention from meeting the book replacement device requirements are inherent in Ziv-El's invention as well.

In U.S. Pat. No. 6,549,751 (2006) Mandri discloses a fully interactive system wherein students would have multiple capabilities. A local network of a teacher's computer and students' computers, it is described by its inventor as, “A bi-directional, real time, teaching system.” A defining characteristic is interactivity between the student terminals and the teacher's machine. It incorporates “a callable teaching assistant means for providing real time, supplementary information that enables the student to correct incorrect answers.” Students routinely submit completed work assignments over the network and send inquiries to their instructors, and instructors and students may even have screen sharing hardware and software. As such, U.S. Pat. No. 6,549,751 goes way beyond what a BRD is and does. The book replacement device may be part of a C4 system that enables a U.S. Pat. No. 6,549,751 implementation, but this invention is not applicable to designing a BRD that simply satisfies the six essential requirements.

In U.S. Pat. No. 6,712,701 Boylan et al (2004) describe a system for using electronic networks to implement wagering. The electronic book can download and display racing forms and updated situational data, and it permits the placement of bets by the user. The electronic book of the patent is a generic tool, and the inventors even identify existing commercially available products to serve as the user's terminal. The nominal screen size is a good-sized 8.5×11 inches, but none of the other aspects of the six requirements of the BRD are addressed.

U.S. Pat. No. 6,895,393 by Numata et al (2005) describes an apparatus and processes for securely selling and delivering electronic books and providing updates to books previously sold and delivered. There is a remote publisher, a local store terminal, a local reader's terminal device, and two interfaces. The interfaces are a locally used IC card encoded with the details of the transaction and a network that connects the publisher, store terminal, and reader terminal. This is a distribution network and processes to support commerce involving a local reader's terminal device. The terminal digital content reader itself is simply a tool to provide a delivery point to the distribution. It is described only in terms of components that support the arrangement and that display the purchased digital content. There is little physical detail provided, and there is nothing about the terminal device addressing any of the six requirements of the BRD.

In U.S. Pat. No. 7,124,100 Pirillo (2006) describes a point of sale terminal for selling, taking payment, and securely delivering digital books into a separate customer contact device which may be an electronic book reader. This is focused on the point of sale terminal itself and its interfaces for distribution. The description and claims for the terminal reader device itself are limited to descriptions of a generic computer with specific transaction-related functions. There are few details of the physical unit such as materials, dimensions, trade-offs, metrics, tests, and specific interfaces, let alone any of the six requirements of the BRD.

Numerous Patents Apply Only at the Subsystem Level of the BRD and not at the Top Tier.

A sample of 25 patents is presented. These patents do not define the electronic book per se but merely provide alternative technical approaches or optional capabilities to be implemented at a subsystem level that may be considered in the trade-off studies for particular products and features. They include U.S. Pat. Nos. 5,524,201; 5,802,516; 6,144,380; 6,243,071; 5,697,793; 5,663,748; 5,761,681; 5,761,682; 6,493,734; 6,597,314; 6,774,884; 6,933,928; 6,985,913; 7,106,296; 7,107,533; 7,165,217; 7,236,966; 7,246,118; 7,362,492; 7,516,073; 7,640,513; 7,714,837; 7,783,986; 7,350,704; and 7,103,848.

Four patents by Shwarts et al disclose techniques for enabling or enhancing the use of electronic books. In U.S. Pat. No. 5,524,201 (1996) they describe preparing an electronic version of a book for a computer system. In U.S. Pat. No. 5,802,516 (1998) they provide a method of controlling an electronic book. U.S. Pat. No. 6,144,380 (2000) provides a method of entering and using handwriting to identify locations within an electronic book, and U.S. Pat. No. 6,243,071 (2001) discloses a tool set for navigating through an electronic book. All four of these apply to the preparation materials to be loaded onto a reader or the manipulation of the materials, not to a book replacement device per se. Further, they apply to the reader itself only to the extent that the reader has a compatible stylus or pointer device, which is not part of the BRD except as a possible optional accessory.

In a similar vein Huffman et al have four patents that disclose applications and features that can be implemented in an electronic book but do not contribute to meeting the requirements of a BRD per se. In U.S. Pat. No. 5,697,793 (1997) they disclose a method of generating and displaying at least one metric which measures the utilization of an electronic book. An example is the speed at which the material is being read. They also provide ways to use the metrics as a user input to control the way the book presents material. In U.S. Pat. No. 5,663,748 (1997) they describe a highlighting feature. U.S. Pat. No. 5,761,681 (1998) describes a method of substituting names in an electronic book, and U.S. Pat. No. 5,761,682 (1998) provides a method of capturing and storing a quote on an electronic book. None of these disclose useful details applicable to the systems level implementation of a BRD but only candidates for trade studies in the subsystems of particular products.

The following are similar in nature.
U.S. Pat. No. 6,493,734 by Sachs et al (2002) describes a way to manipulate views of the content resident in an e-book, an enhancement feature that works at the sub-subsystem level.
Beezer et al in U.S. Pat. No. 6,597,314 (2003) describe a way to provide easier access to help functions for readers of digital materials on a generic computer.
In U.S. Pat. No. 7,165,217 Kondo (2007) provides a way to implement underlining and highlighting in displayed content of an electronic book
U.S. Pat. No. 6,985,913 by Murata (2006) describes a way to have images of celebrities downloaded and displayed on an electronic book in such a way that these people seem to be reading the book aloud to the book operator. The book text also appears, and, by use of a balloon or other highlighting, the portions being read are made to stand out.
In U.S. Pat. No. 7,246,118 Chastain et al (2007) disclose a method for electronic book users to share specific tagged passages in e-books on their machines via a connecting electronic network.
In U.S. Pat. No. 7,714,837 Hsieh (2010) provides an apparatus that can be implemented in an electronic book to enhance the user interface with regard to page turning, given that the content is already inside the machine.
Three Barsness patents provide for improved collaboration and information sharing tools. In U.S. Pat. Nos. 7,783,986 (2010); 7,350,704 (2008); and 7,103,848 (2006) he describes a way to bring a portion of an onboard digital document to a screen; to highlight a section of that material; and to create annotation files such as definitions, context, and comments that can be shared among users. The other users can be on the same machine and other machines. The patents also provide for use of usage data and statistics.

In U.S. Pat. No. 6,774,884 Shimoda et al (2004) describe how electrophoretic ink works, the manufacture of the sheets, and how it interfaces with an electronic book. This applies to one alternative technical approach for the display subsystem.

In U.S. Pat. No. 6,933,928 Lilienthal (2005) describes an electronic book with both aural and visual outputs. These can be enjoyed together, or the user can select for the output to be limited to the visual or the aural channel only. Output devices are found in the handheld unit itself, in an eyeglass-type display, and in headphones. The invention allows changes in the displayed character size to accommodate vision deficiencies. It is a user enhancement applicable to the display and presentation sub-tier. The electronic book itself is described only in regard to the number and type of specific electronic components and capabilities needed to implement a generic machine with the specified output selection capabilities. There is almost no physical detail, let alone reference to the six requirements of a BRD. Additionally this invention does not use external interfaces to download materials; it uses inserted ROM devices only, which is antithetical of the BRD fundamental mission to eliminate physical devices.

Similarly in U.S. Pat. No. 7,107,533 Duncan et al (2006) disclose a configuration of electronic book with two outputs, a graphical output and display and an audio output and playback. There is a sensing and processing capability such that data presentation can be audio over a speaker and visual over a display at the same time and which enables annotations to either of the outputs to also be applied to the other as well. It acts at the presentation sub-tier.

In U.S. Pat. No. 7,106,296 Jacobson (2006) describes an electronic book with separate internal pages containing a plurality of reconfigurable electronic displays so that the reader has the appearance of a traditional book, but the content of the pages changes as needed to display whatever material is of interest at the moment of use. This invention operates at the user presentation level, not at the top tier of a BRD

U.S. Pat. No. 7,236,966 Jackson et al (2007) describes a research and data retrieval system wherein a user can submit a query to a remote database over an electronic network, have the applicable portions of the digital content copied and set aside, and have the data collated into a virtual binder downloadable as an electronic book. This arrangement applies entirely to remotely trigger-able delivery capabilities on the supra system side of the demarc, not to a BRD machine.

In U.S. Pat. No. 7,362,492 Kastalsky (2008) provides a design approach to implement a specific type of display mechanization, specifically bi-stable electronic shutters.

In U.S. Pat. No. 7,516,073 Kodama (2009) describes a system to implement reading an electronic book or books aloud. It supports remote downloads; synchronizes and bookmarks the start and stop points; provides special capabilities regarding time intervals between uses; and may operate with more than one electronic book. It uses RFID tags for identifying specific objects and eliciting data therefrom. It acts at the presentation sub-tier.

In U.S. Pat. No. 7,640,513 Card et al (2009) disclose a system providing very powerful tools for organizing and manipulating voluminous and complex data in a computer. It provides an existing commercial product for the hardware as a baseline and invites use of any compatible machine. The physical realization of the invention is a set of computer program products. The virtual three dimensional book functions like a warehouse with multiple sections subdivided into rooms, each of which contains numerous storage bins which are compartmentalized. This invention is about sorting, organizing, manipulating, and presenting electronic information. It ameliorates the display and manipulation of large aggregations of data upon relatively small display screens.

A Group of 32 Patents Involve Machines Identifiable as Top Tier Electronic Book Variants.

These are the inventions that come most closely to the BRD. That is, superficially they appear to be similar to the BRD. Close inspection of this group, however, reveals there are significant gulfs between each of these inventions and the requirements for the book replacement device. The inventions range from designs for individual electronic books to those describing systems for the distribution of digital data. The latter are in this section because they include detailed enough descriptions of the terminal storage-reader device that they belong here. The 32 are identified below.

5,417,575 McTaggart (1995)
5,534,888 Lebby et al (1996)
5,645,432 Jessop (1997)
5,761,485 Munyan (1998)
5,810,604 Kopp, Jr. et al (1998)
5,847,698 Reavey et al (1998)
5,956,034 Sachs (1999)
5,956,048 Gaston (1999)
5,957,697 Iggulden (1999)
5,986,690 Hendricks (1999)
5,991,594 Froeber (1999)
6,229,502 Schwab (2001)
6,313,828 Chombo (2001)
6,320,591 Griencewic (2001)
6,335,678 Heutschi (2002)
6,557,173 Hendricks (2003)
6,642,909 Oliva (2003)
6,792,243 Ka-wah et al (2004)
6,886,036 Santamaki et al (2005)
7,020,663 Hay (2006)
7,298,851 Hendricks (2007)
7,299,501 Hendricks (2007)
7,336,788 Hendricks (2008)
7,401,286 Hendricks et al (2008)
7,509,270 Hendricks et al (2009)
7,748,634 Zehr et al (2010)
7,716,349 Hendricks (2010)
7,835,989 Hendricks et al (2010)
7,849,393 Hendricks et al (2010)
7,865,405 Hendricks et al (2011)
7,865,567 Hendricks et al (2011)
7,880,688 Silverbrook (2011)

Together these patents pretty well describe a generic electronic book with noted excursions toward some specializations. Just as a generic jacket is inadequate to the requirements of a Chicago winter, no such generic electronic book will succeed as a BRD.

It is helpful to review what the six hard requirements that define the BRD. Then it can be seen how far the group is from addressing them.
Focus on and create requirements for an end-user device, a machine that at the least is capable of replacing as many separate types and titles of hard copy textbooks and reference books as practicable under system constraints and configuration control, including architectural constraints, whether deployed as a separate product or as a separately deliverable configuration item within a delivery system product
Provide presentation equal to or better than hard copy books
Be highly resistant to accidental damage such as characterizes school children's usage
Be highly theft-resistant inherently
Provide protection of the source, data, receiver, and user from malicious or accidental events during the downloading, presentation, and storage of the data and maintenance of the machines
Be as affordable or more affordable than hard copy books in acquisition and life cycle costs

For the example consider the relatively simple-appearing requirement of data presentation. For the BRD the presentation has to be as good or better than in text books and able to support the range of visual acuity found in school populations. Such performance encompasses a large number of parameters having to do with how finely the image can be dissected on the one hand and the tightness or expansiveness of the perspective on the other. In optical systems these are nominally what resolution and field of view mean, and, for a given detector configuration or a given display magnification, the one normally can only be increased by decreasing the other. In electronic displays which offer magnification capabilities the equivalent to resolution and field of view is the matched pair of (1) resolution for a given size of the scene and (2) the corresponding level of magnification between zero and the limit of the machine.

Let us consider specifically resolution first. Actual resolution in the visual acuity meaning is a radial measurement of how small an object or piece can be and still be distinguished as a separate piece. That depends on the size of the individual pixels that emit, reflect, or block the light; the pattern of the pixels; the separation of the pixels; whether it is a monochrome or color display; if the latter, the number of color levels; the contrast between the background and the object; the intensity of the light source; and a number of other parameters. Unfortunately most of the time that the resolution of a display is called out it really only reveals the vintage of a specific machine's design and the nominal performance of that display for specified manufacturing and test conditions. Such static descriptors don't tell what the system overall can do given a wide range of input data needing to be displayed or the ambient conditions affecting the user. For a book replacement device, however, the ultimate objective performance must be addressed as well as the environmental conditions. Then the specifications for the equipment with which to populate the system can be drawn out through design trade studies. To take the issue even further, the successful BRD must not only provide adequate pre-specified performance under specified conditions, but it must do it under simultaneous constraints in weight, size, ruggedness, and all the requirements previously disclosed.

This is why the recent medical discovery cited earlier is so pertinent and revealing. Users of handheld displays like texting machines have reported eye strain and headaches due to having to hold their units too close to their faces in order to read the small text. To reiterate briefly, the combination of an extremely small screen, the availability of extremely small font, and a desire to have at least a minimum level of text density on the screen resulted in the unhealthy practice of staring into the screen from too close a perspective. This is exactly the kind of thing to avoid in a text book replacement device, and that is why formal requirements for its development are a necessity. It is not enough to rely on static, nominal performance descriptors with regard to providing the ultimate performance. Nor is it wise policy to assume commercial suppliers will think these issues through and get it right on their own.

In some of the patents there is some attention to the resolution, usually by calling out the descriptor for whatever is the highest commercially available unit at the time, like SVGA. Some cite a minimum number of colors the display must have available, such as 256 colors. Does that mean the display cited will be good enough for a nominal group of students to read size 12 Arial font on a white sheet under classroom lighting? How about size 8, Times New Roman, brown, italicized type on a green portion of a multi-colored map with black contour lines? Such ultimate system performance could not be determined for any of the patents from the way the inventions have been described in the specifications and in the claims, but such determinations typify the hard requirements of the BRD.

Maps present a special set of challenges. For a given display model the resolution is associated with a specific instantaneous field of the view of the presentation. A specific model of display may provide adequate resolution for text passages, but it may not be adequate to support the presentation of maps when the screen is no larger than a standard sheet of paper. The available screen size may be inadequate to see the desired details and the big picture at the same time.

A physical example shows why. A map of the U.S. with the outlines of the States can fit on an 8.5×11 inch sheet of paper. How big would the map have to be to show the whole United States and at the same time accurately portray the true shape of all the counties within each State? That might be a two feet on a side. How big would it be to show the country as a whole and the actual shape of every town with more than 10,000 people? When the size of the objects to be depicted gets smaller, it means that the resolution is increasing. As the needed resolution gets finer, tighter, and smaller, the size of the physical map gets bigger. The area of the map encompassed within a specific portion of the viewer's eye's field of view, however, gets smaller and smaller. Thus increasing the resolution means decreasing the instantaneous field of view and vice versa. On a physical map, if you need to be able to see very small details and the big picture for a very large area, you either need a very large map or a magnifying glass.

In an electronic display you have a fixed, small screen so your image simply can't keep getting bigger. Instead you have to provide magnification so you can zoom in to a clear scene with the finest resolution and a very small scene area and zoom out to the largest scene area with whatever resolution corresponds. The colors in the background, in the objects, and in the text will play a part in what can be perceived in a scene and what is blurred. Even the optical coatings on the screen and the technology selected for the touch screen controls, if used, may have an impact on what is discernible and what is not. Will the size 8, Times New Roman, italicized, brown font on the green portions of the contour map be legible or not? That's the kind of issue that leads to specified requirements for resolution, field of view, magnification, color, and a number of other factors.

This is a very superficial treatment of the subject of optical discrimination. With respect to even these cornerstone parameters of presentation, though, the 32 patents in this group have only spotty coverage. Most of the inventions do not address resolution at all. Most of those that do discuss resolution are in the Hendricks subset, and none of these goes further to also address either magnification or zoom. There are three inventions that do cite both resolution and magnification in some way, but they are not in the Hendricks subset. Of the entire 32 patents only three cite resolution, magnification, and the use of color in any manner that is related to visual discrimination and resolution. Where values are specified they represent a static citation of what was high performance at the time of the writing. There is nothing that discloses that the variables that drive these parameters need to be addressed, let alone that they are critical. Nothing indicates a need to match the equipment design to pre-specified, required levels of performance that are demonstrable under multiple, simultaneous physical and other constraints.

In addition to having very limited references to visual discrimination characteristics there is little attention across the group for the required physical characteristics or to information security. Lacking in most members of this group are specific details and discussions of dimensions, materials, damage resistance, information security, and cost constrained development, all of which are critical to the BRD. Some patents definitely do come closer than others. U.S. Pat. No. 5,761,485 by Munyan (1998) has more physical details than the others. U.S. Pat. No. 7,298,851 by Hendricks et al (2007) goes deeper into information security than the others. As will be shown in the next paragraph, none of the 32 comes close to congruence with the BRD, and there are significant gaps for even the closest.

To assess and then concisely portray the extent of this characteristic of incongruity to the BRD for the whole group of 32, word searches were conducted using Microsoft 2003 Word on the patents as downloaded from the U.S. Patent and Trademark Office web site. The object was to see how frequently the specific terms that normally are used to provide design specifics or define performance in relation to the six requirements appear in the 32 patents. Nineteen terms and character strings were selected that are closely associated with the requirements. Note that the terms theft and stolen can be used be with either or both of theft resistance and Information Security/Assurance.
Presentation terms: (1) resolution (2) field of view, zoom, or magnif (Magnif is not a misspelling but a way to catch multiple terms beginning with this string of letters.); and (3) color
Physical description terms: (1) inch, centimeter, cm, millimeter, or mm; (2) plastic; (3) metal; and (4) aluminum
Damage resistance terms: (1) rugged and (2) damage
Theft resistance: (1) theft and (2) stolen
Information Security/Information Assurance terms: (1) theft; (2) stolen; (2) password; (3) authenticat (Authenticat is not a misspelling but a way to catch multiple terms beginning with this string of letters.) (4) assurance; (5) integrity; (6) verification; (7) hashing; and (8) digital signature
Cost constraints in Development, Acquisition, and Support terms: (1) budget

With 19 terms and 32 patents, there were 608 patent-term pairs possible where a term showed up at least once in a patent in a usage and application consistent with its usage in the BRD requirements. The possible uses for theft and stolen in more than one category per patent were treated as giving twice the opportunities, but their absence in a patent was only counted once. A usage criterion example is how metal was counted. The term metal was counted as present if its usage pertained to a type of material from which the case or enclosure of the BRD might be manufactured. It was not counted if it was applied to a wire or a slot in the interior of the assembly. Plastic counted in the same usage but not if it was used to describe a translucent material used to form leaves or pages within a folding book emulator. Units of dimensional measurements counted if they were applied to the external size of the unit, enclosure, or casing or the display screen but not to something like the size of the PC card or the CD drive.

Collectively the word searches found only 73 out of the 608 possible pairings where a specific term was found in at least one place in a given patent. Four words never were used: rugged, stolen, assurance, and budget. Three words appeared in only one patent each: integrity, verification, and hashing. Two more appeared only twice in the entire group of 32: aluminum and damage. Resolution was used in one half the inventions, 16 patents. The next leading term was password in 11. No patent had at least half the words in it anywhere. One patent had nine of the words, and another had seven. The former (U.S. Pat. No. 5,761,485 Munyan 1998) touched on most of the physical details lightly and missed most of the information security. The latter patent (U.S. Pat. No. 7,298,851 Hendricks et al 2007) was strong in information security and lacked details in the physical.

To summarize, none of the 32 patents cited in this section shows any recognition of the existence of the engineering requirements to take a generic electronic book and make it successful in large scale deployments in the public school systems, let alone the specifics of how to plan, organize, specify, and meet those requirements. Where the inventions do intersect with any of the six requirements of the book replacement device, all the points of intersection are closely circumscribed and in most cases very shallow.

### Existing and Expected Related Products

The first related class of products is the laptop or other personal computer. These systems may be acquired in standard versions which are highly autonomous or in less capable configurations. The standard versions have their own powerful processor, memory, and storage. The alternative approach is called a thin client.

A thin client is a computer that lacks some feature or capability found in a standard computer. It is able to fulfill its mission only by drawing the nonresident functionality from the supra-system to which it is attached. Within the supra-system is a computer whose functions include providing the logic and controls to make the thin client work. At the extreme limit of thin clients is the device called a work station. The work station has a display but contains no autonomous capabilities except key stroke readers in the keyboard. Key stroke readers note the key strokes of the user and send them to a higher level system which has the logic and power to interpret and carry out the user's intentions and desires. As the higher level system performs the tasks on behalf of the work station it sends to the work station display whatever data and presentations the operator needs to know or to have available. Functionally the work station appears to be a standard computer, but the hardware at each seat is much cheaper, the supra-system cost aside.

Any computer that has functions beyond the authentication, selection, presentation, and support functions identified in previous sections of this Specification as inherent functions of the book replacement device contains cost generating elements for capabilities that exceed the basic requirements. They are therefore not a lowest cost approach for the specified functionality and are therefore outside a disciplined affordability range. Also, commercially available computers almost never meet the ruggedness requirements of the system envisioned. Moreover portable computers are popular theft targets, and they only gain loss resistance through added features such as the backtrack software described earlier. Even such software is not a reliable talisman against loss. There is no assurance, for example, that malefactors who have been successfully tracked to their hideout will not get rid of the evidence prior to capture if able by throwing it into a deep river or out of a speeding vehicle.

A keystroke reader thin client is intended to allow a high degree of versatility up to the capabilities of a full function computer at every work point but at a much lower cost per seat. It only functions properly when connected to the machine which provides the capabilities not resident in the work unit. This is virtually the opposite of the requirements for the book replacement device, which is fully autonomous to the extent of its specified functionality. The BRD is attached to the C4 system on an exception basis. It is connected only as necessary to download materials and for security and logistics operations. Additionally the book replacement device will have file security and quality capabilities that in most thin clients will be allocated to and sited in the master computer of the supra system.

The second class of related products includes the rugged laptop and the tablet commercial computer. The latter is frequently a portable point of service system used in rugged service or where the environment has an elevated probability of damage or environmental stress. Policemen, firemen, and utility line workers typify the more demanding, all-weather users for ruggedized machines. Among the users working in less severe conditions are delivery personnel and mobile technicians. To a very high degree the workers using these systems need them for command and control interface to their companies' dispatch, operations, and inventory systems or for other interactive networked functions. These hand held devices are specially packaged computers that have varying degrees of such interactivity with the higher level systems. The level of protection to the internal components varies according to the specific usage, but to be considered rugged they typically will have explicit references to the military or industrial standards, or both, to which they were designed and tested. According to the manufacturer's specification sheet, one popular model of tablet used by policemen has a screen measuring 14.2 centimeters (5.6 inches) in the diagonal, a weight of 1 kilograms (2.3 pounds), and an exterior dimension set of 18.3 centimeters×15 centimeters×5.6 centimeters (7.2 inches×5.9 inches×2.2 inches). The weight includes the strap and two batteries. It is extremely ruggedized, specifically to IP 65 and able to withstand 1.8 meter (72 inch) drops. It is reported to cost several thousands of dollars. Such ruggedness and cost are way beyond the students' machine needs.

Ruggedized laptops and tablets meet, or more frequently exceed, the ruggedness criteria for the book replacement device. To the extent that they have authentication processes and other IA features such as restrictions on their download sources they have some security features at the assembly level. Those that have unique shapes or colors have theft resistance along that one axis. Such machines may nonetheless still be attractive as sources of disassembled parts, and there are other points of departure.

Any interactive functionality between the devices and the home-base or networked systems is well beyond the limited capabilities described for the BRD. To the extent that the tablets have a specific requirement to update external data files they definitely have a capability not encompassed by the book replacement requirement. The relevant cost components for these capabilities are entirely alien to the authorized costs for the book replacement. Another obstacle is that most point of service tablets do not have nearly a large enough flat display to present school quality maps and graphics with enough field of view and resolution simultaneously. If they did have such displays, they would be cumbersome for portable service. A major point of departure from the solution set is their price, which is several thousand dollars for devices with enough size to display text book content. They are also relatively heavy. To make them compatible with the BRD requirements would require major changes to the size and shape; reduce the hardening; and redesign the controls, displays, and functionality. Given that school systems' student populations are not typically the addressed markets for the manufacturers of these machines, it is unlikely that such development will take place.

There is at least one company that sells what it calls semi-rugged computers. This company has identified three types of protection for a computer as the main features needed to prevent the vast majority of expensive, accidental damage. These are damage by being dropped, damage from having something dropped on it, and damage due to having liquid spilled on it. Various standard ruggedizing techniques are used that are well established in multiple industries. The degree of hardening for this company's products is limited to typical work or school scenarios. Their shock protection, for example, is designed for a 76 centimeter (30 inch) fall from a desk.

While semi-rugged computers are not as incompatible with the book replacement device requirements as are standard computers, they do share all the other deficiencies of standard portable computers except for damage resistance. They do not meet the shape or size needs, and they are theft targets rather than being theft resistant. They are more expensive to acquire than standard portable computers, which themselves are more expensive than is acceptable for the extremely large number of book replacement devices needed to eliminate hard copy.

A highly specialized form of the tablet computer called a reader is found in the current implementations of the e-book sold to allow readers to download and read novels. These machines are specialized for downloading books and have readability features on the order of what is needed in most hard copy book replacement devices. Their electronic componentry reflects the limited mission of the readers as opposed to a general purpose desk top or laptop computer. At least three different major companies offer e-book readers with an abundance of features, and yet their processors are only rated between 532 MHz and 800 MHz. This is considerably less powerful than the processors on full purpose computers, which currently typically run at about 2.5 GHz and higher. The e-book readers have from 2 GB to 8 GB flash memory, again a very small amount versus regular computers where the current standard is at least 160 GB even in laptops. Nonetheless this small capacity is probably more than enough for most e-book users; it is enough to hold well over 1,000 novels at a time. Additional memory is available via optional memory chips. By different types of display technologies all three companies' designs provide highly readable text, and their color and gray scale quality are excellent.

Structurally e-book readers can be very simple. At least one major design uses a four layer sandwich. The main layer is an assembly consisting of a single printed circuit board (PCB) to which is taped the display assembly. The display uses e-ink, short for electrophoretic ink. E-ink displays are essentially flat. They form dynamically changeable patterns of letters and images which are controlled by electromagnetic cells. The patterns formed reflect whatever light strikes their surface. The patterns are actually collections of individual points of very high resolution, and they essentially work like traditional ink droplets on paper to reflect impinging light. E-ink machines do not need backlighting, and they are lighter, thinner, and much more energy efficient than LCD-configured machines. Other than the battery and the wireless card all the electronic components of the e-book reader which are not part of the display or the external interfaces are on the PCB. The PCB-display assembly is itself screwed to the second layer, which is a plastic sheet. This plastic sheet is also where the battery and wireless card are mounted and attached. This two layer assembly of the PCB-display assembly and the populated plastic sheet is sandwiched between a bottom plate and a top plate. The latter has cut outs for the display screen and touch point controls. This is a simple and relatively inexpensive design to manufacture.

The weight range of three leading competitors runs from approximately 141.7 grams (5 ounces) to approximately 538.6 grams (19 ounces). Thickness is between 0.8 centimeters and 1.8 centimeters (⅓ of an inch to 0.7 inch). Screen sizes range from 12.7 centimeters (5 inches) in the diagonal with a 14.5 centimeters by 28.0 centimeters (5.7 inches by 11 inches) front face to just under 25.4 centimeters (10 inches) in the diagonal with a 26.4 centimeters by 18.3 centimeters (10.4 inches by 7.2 inches) face.

At least two of the brands use LINUX operating systems. At least one of the manufacturers has indicated an intention to actively encourage independent development of applications.

The existing e-book readers are collectively an excellent example of how focusing on the essentials allows success with economy. They cost a few hundred dollars each, depending on the brand, model, and features, and they display the downloaded text very well. Additionally, by using LINUX-based operating systems and cooperating with developers, at least one design offers potential cost savings both in the acquisition and over the life of the system by allowing alternatives in system support. Thus the current designs are close to what the book replacement device needs in some aspects, but they do have some major disqualifying short comings. They currently do not fully meet the size requirements because they are shaped to resemble paperback novels. Going to the larger size means the manufacturers would have to purposely address a whole new market, a major step with enormous business risk and entailing the development of entirely new processes and controls. After all, transitioning from manufacturing articles for the consumer market to manufacturing articles that can stand testing in accordance with MIL-STD-810 is at the very least an ominous sounding project. The main deficiencies by far, though, are in a lack of ruggedness and theft resistance.

There is a specialized electronic textbook system (e-text) currently on the market. It consists of specialized texts in digital form that can be downloaded to a standard desk top or laptop computer once the machine has had the e-text seller's special software installed. The software requires Windows XP or a more recent operating system for compatibility. The system requirements are the same as the minimum for Windows XP, as follows:
Pentium 233-megahertz (MHz) processor or faster (300 MHz is recommended)
At least 64 megabytes (MB) of RAM (128 MB is recommended)
At least 1.5 gigabytes (GB) of available space on the hard disk
CD-ROM or DVD-ROM drive
Keyboard and a Microsoft Mouse or some other compatible pointing device
Video adapter and monitor with Super VGA (800×600) or higher resolution
Sound card
Speakers or headphones

The computer processor needs to be from the Intel Pentium/Celeron family, the AMD K6/Athlon/Duron family, or the equivalent.

These requirements for a computer to run e-texts are less than the capabilities of the e-novel readers. As previously noted, one of the e-reader suppliers, Barnes and Noble, has stated on their web site that the reason e-novel readers are not compatible with the electronic text is because of display size inadequacy for the full range of illustrations in textbooks. This would encompass field of view, resolution, and imagery requirements. Even were such not the case, this approach has all the limitations and drawbacks of the computers on which it is operated. It lacks ruggedness, theft resistance, some aspects of security, and affordability.

The last class of systems encompasses the defense articles. These include ruggedized flat panel displays with various interface designs. Their designs are customized for aircraft, ship, submarine, and ground vehicle deployment. Many of these types of displays can meet the ruggedness requirements and the surface area size requirements at weights equivalent to several large text books. Some military displays have handles for easier handling. Their design and manufacturing address environmental requirements far beyond what is needed in school systems, and their price is vastly higher as a result, $5,000 and more. While no display is designed to fit every type of military platform, each is designed for the extremes of military service. Their capabilities include the ability to withstand explosive forces that would shatter commercial devices; temperature extremes from well below freezing to 125 degrees Fahrenheit and higher; radiation resistance; anti-fungus features providing resistance for extended operations in tropical marshes; explosive decompression; and similar exceptional circumstances.

More than being simply over-hardened and overly expensive, though, military displays lack important capabilities. They get signals via diverse analog and digital circuits and manipulate them with specialized circuitry to create a display. Given that they are attached to military circuits, the incoming signal is assumed to be unadulterated and authorized. Thus they lack IA capabilities. These functions are generally carried out in other parts of the system to which they are attached. Additionally, like most televisions and standard computer monitors, they don't store data per se. To avoid instability in the signal going to the display despite fluctuating line inputs they may have electronic buffers that cache data and function like accumulators. Such buffers involve a very small amount of data, and the storage is temporary. They lack theft resistance because generally they are physically guarded from unauthorized personnel, although those with built-in carrying handles are conspicuously not consumer products. A main point of departure is in their manufacturing processes. Military displays are not assembled on what would normally be considered true mass production lines, which is the way current e-novel readers are manufactured and then profitably sold for a couple of hundred dollars each. Military displays are produced in low volume, highly controlled conditions and small quantities.

To summarize, to adapt military displays would require major electronic redesign to add storage, librarian, and security functions; to provide distinctive external features where such is lacking; to replace components that would otherwise increase their value as theft objects; and to delete unnecessary signal processing capabilities. This is in addition to completely redesigning the hardening features, packaging, and possibly most importantly, the production processes. Even more than with e-novel readers, adapting defense display technology to a BRD would require the manufacturers to engage with a whole new market, one with vastly different characteristics than their traditional customer base.

There are military thin client displays. They have all the short comings cited earlier for thin clients except for a lack of ruggedness, and they have the same problems as military displays except in the degree of autonomous signal processing.

### Summary of Shortcomings in the Prior Art

There are no devices in the prior art that do not require significant modification to meet the requirements of the book replacement device. The individual aspects of the replacement device requirement are well understood and widely supported. The products and markets that do so, however, are divergent from BRD market and unlikely to spontaneously converge thereto.

Developers focus on specific markets and therein either fix problems or offer attractive new capabilities, or both. There is no perceived, unaddressed unique market for textbook replacement devices as described in this Specification per se. Current school systems' efforts, the interactive systems and the use of commercial e-readers and laptops, do not address the full set of requirements, and they will not solve the problem. Developers of e-novel readers are busy fighting each other for the growing consumer market of people who love to read. There is little to justify these manufacturers' diversion of resources to enter a market populated by conservative buyers with very tight budgets and enormous skepticism.

No serious efforts will be undertaken to harden the vast majority of portable computers against even predictable, routine damage until is perceived as a decisive need, which is not in sight. There is little being done to increase theft resistance beyond Lojack® for Laptops and similar tracking systems. Virtually nothing has been done to provide distinctive visual and tactile cues regarding ownership. Most companies' products are delivered in identical appearance, and conspicuous color schemes and distinctive physical features and indicia are rare. In fact it is a technique of brand development to have the colors and styles of the products reflect the manufacturer's identity, not the customer's. Additionally, the concept of increasing the theft resistance by reducing the machines' inherent value is completely opposite to the current pattern. Few machines implement information security and information assurance beyond the use of passwords and the use of public key infrastructure (PKI) certificates for secure transactions. File verification is not the norm, and anti-virus and Internet protection are treated as owner options.

The replacement device's manifold requirements span multiple disciplines. These comprise education; mechanical, electrical, and software engineering; and cross-discipline specialties like system durability, physical security, and information security and assurance. With neither the buyers nor the sellers recognizing the uniqueness of a textbook replacement and its potential payoffs, it is unlikely that any fully integrated requirements set will be drafted. In the absence of a guide such as in this application the probability of first shot success of an optimized device that fits into no currently perceived niche is low.

### Objects and Advantages

Accordingly, besides alleviating the shortcomings of the prior art, several objects and advantages of the preferred embodiment are:
(a) to allow replacement, either in a progression of any pace or as a block, of textbooks and references by portable electronic devices which are affordable; resistant to damage and theft; compatible with school and other organizations' information technology infrastructure; well equipped to provide full information assurance; and which offer other advantages in life cycle cost with no loss in content or presentation;
(b) to provide a device that is functionally equivalent to or better than the items replaced while being as good or better for the fiscal management for the organizations involved and better in every way for student health;
(c) to provide these advances by formally recognizing the actual need, defining a requirement focused exclusively on solving that problem, and synthesizing a near-term solution that synergistically combines elements of disparate existing professional knowledge areas, disciplines, technologies, and practices.

### SUMMARY

A single, versatile device issued to each student for replacement of hard copy books is one element, the end-user element, in a distribution or content delivery system. The book replacement device, hereinafter called the handheld library, is a receiver-storage-display device. The rest of the content delivery system exists now or is being deployed. The physical and functional demarcation between the handheld library and the remainder of the system is clearly defined. The invention of this patent encompasses only the handheld library; the rest may referred to as the supra system, the organizational C4 system, or the organizational IT system.

The present invention encompasses handheld library devices which may or may not have interactivity with the supra system beyond the most basic. The preferred embodiment is not interactive with the higher level system to which it is attached except for very limited security and logistical purposes. Specifically the interactivity is limited to identity verification and user authentication; the selection and secure, reliable, and accurate delivery of materials to be downloaded; the format for the display and other details of the presentation; and technical support. The use of PKI certificates to confirm the identity of prospective download sources and the use of reference verification software is also encompassed in the download process and for ongoing quality control. Interactive capabilities beyond those cited are not resident in the handheld libraries of the preferred embodiment. Such capabilities may be sited in the supra-system and may be implemented via the handheld library interface, but capabilities for interaction in themselves are not a defining feature of the preferred embodiment. The interface to the supra system is addressed in this patent to the extent necessary for integration in operations and support now and in the future.

In accordance with the preferred embodiment the machine comprises a plurality of physical and electronic features that make it adequate for the required tasks; hardened against routine damage; of relatively low value to thieves either as a whole unit or disassembled for parts; conspicuous in its identity and with regard to the identity of its rightful owner; and convenient, safe, and economical for the digital asset owners, the students or reference-users, and the organizations which deploy the devices. It is by design slightly behind the cutting edge of technology compared to contemporary electronic devices. It is versatile for its intended mission in that it can display all textbook content, and with the passage of time various types of aural and video content, but it cannot be easily used for any other purpose. As electronic technology advancements make additional features and capabilities not only practical but somewhat pedestrian they can be added without making the handheld libraries more desirable to thieves or to their criminal customers.

### DRAWINGS

### Figures

FIG. 1 depicts the information management environment within which the present invention will function and specifically the relationship between the book replacement device and the rest of the school and extra-school systems.

FIG. 2 tabulates the conditions for which MIL-STD-810G has descriptive materials and test instructions.

FIG. 3 displays the IEC 60529 IP codes for protection against solids.

FIG. 4 displays the IEC 60529 IP codes for protection against liquids.

FIG. 5 tabulates the IEC 62262 IK codes for protection against impacts.

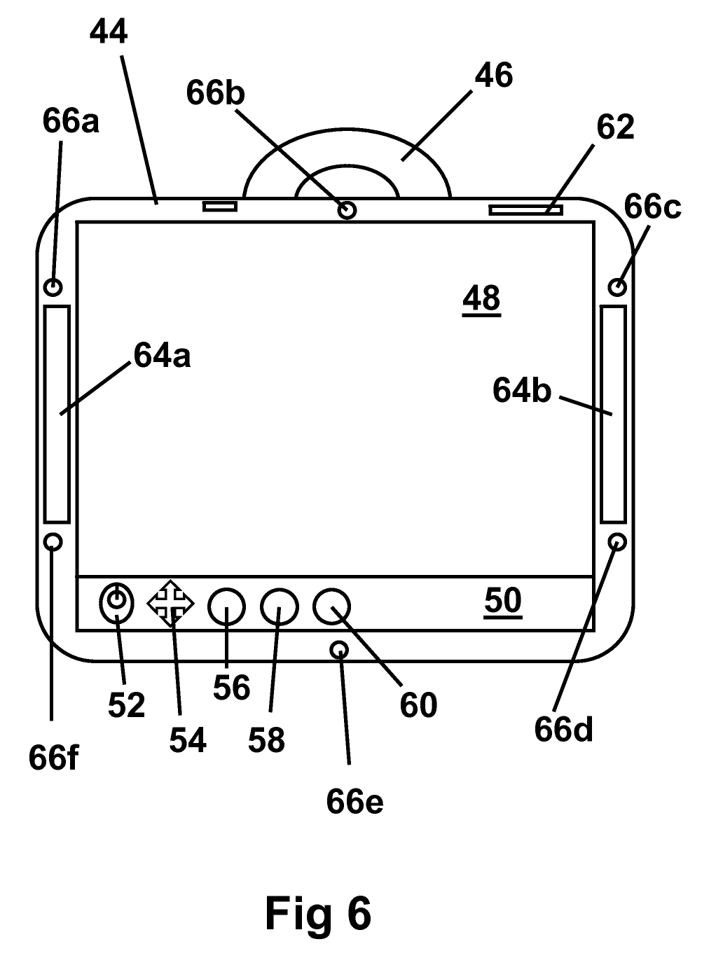

FIG. 6 depicts the top face of the preferred embodiment.

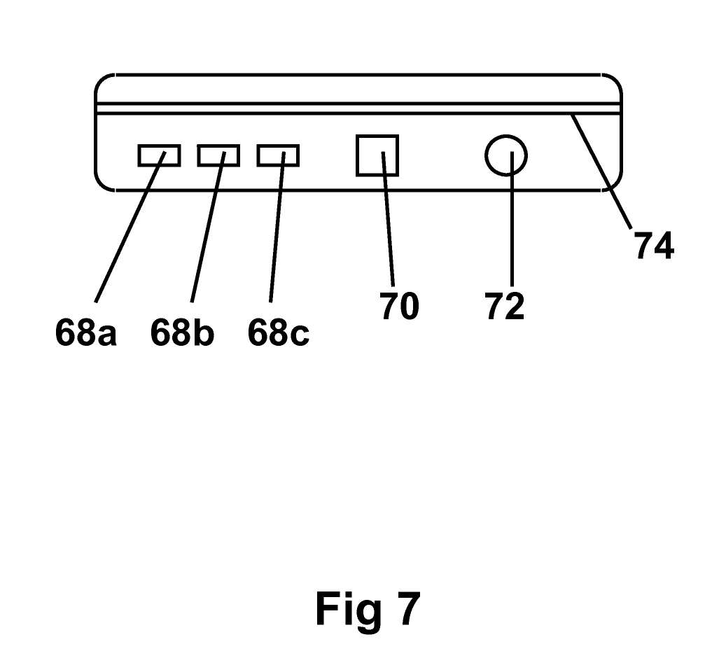

FIG. 7 depicts the view of one side of the preferred embodiment.

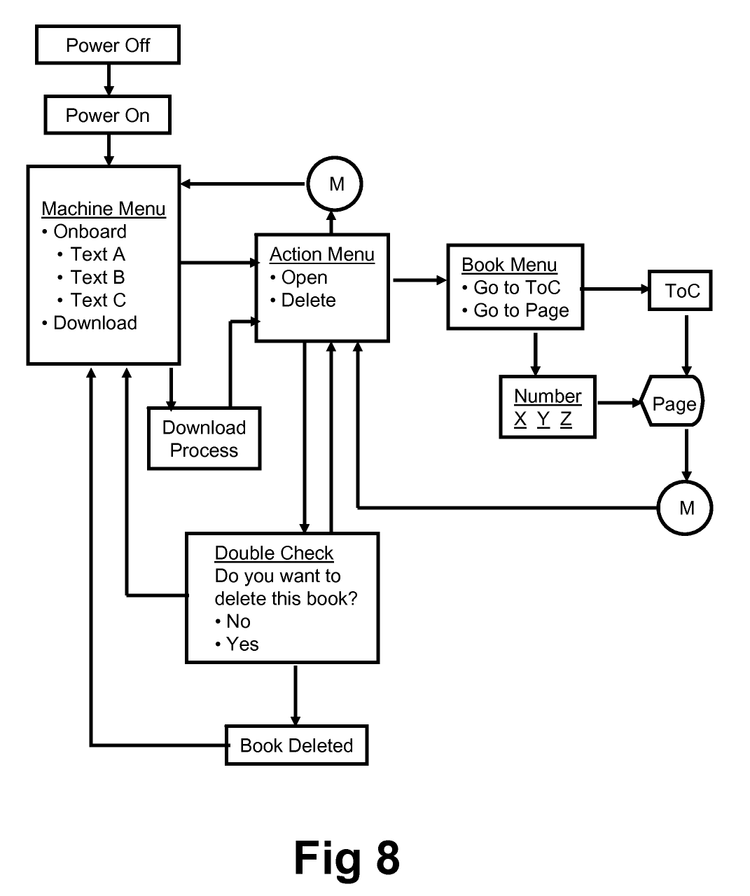

FIG. 8 depicts the flow chart for operating the handheld library as a user.

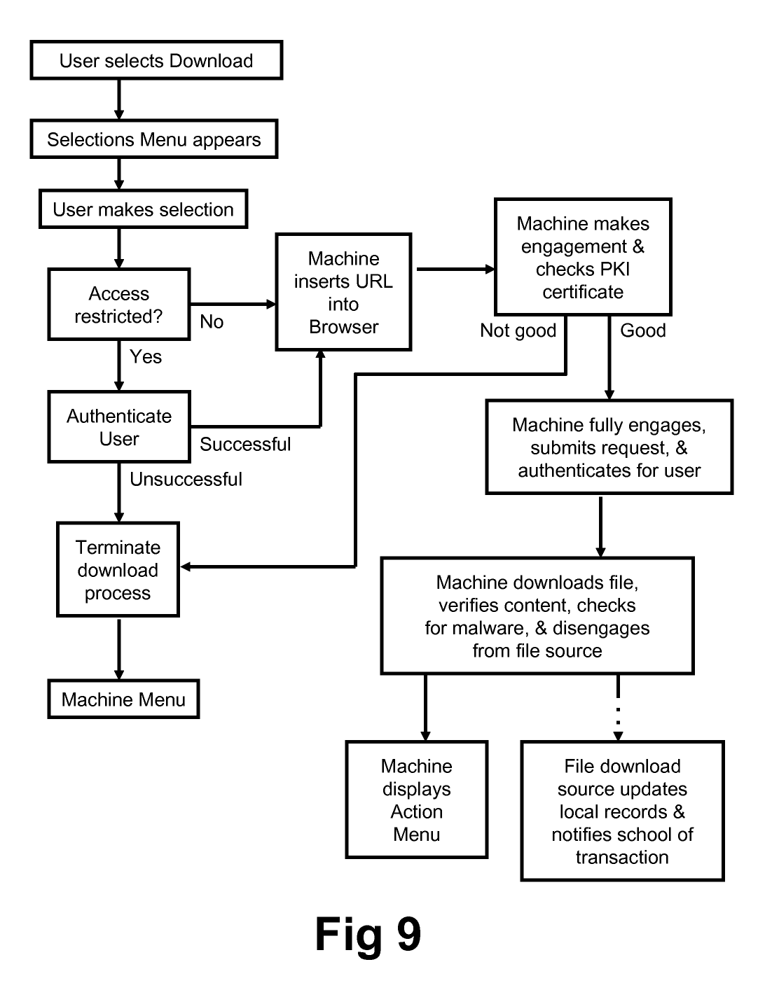

FIG. 9 depicts the download process.

### REFERENCE NUMERALS

20 Book replacement device machine
22 School system command, control, communications, and computer (C4) system less peripherals
24 Local area network (LAN) cable
26 Interface device for book replacement device into C4 system
28 Network-capable machine containing digital library database
30 Interface medium
32 Interface device for digital library database machine into C4 system
34 Extended school system C4 system with all components
36 School system Internet service provider (ISP)
38 Gateway computer subsystem for school system
40 Local loop interface between school system gateway and ISP
42 Demarcation point for wire, fiber optic, and wireless connections between the book replacement device machine and the C4 system
44 Exterior case structure
46 Carrying handle
48 Display screen
50 Control panel
52 Power switch
54 Four way switch
56 Selector switch
58 Menu switch
60 Zoom switch
62 Radio frequency identification (RFID) tag
64a and 64b Locations for engraving indentia including school system name, serial number, and similar data and a bar code
66a though 66f Screws for attaching top panel to bottom assembly
68a through 68c Universal serial bus (USB) ports
70 Local area network (LAN) port
72 External power receptacle
74 Rubber perimeter gasket and isolation sheet

### DETAILED DESCRIPTION OF THE INVENTION

### Preferred Embodiment

### Physical Description

The physical description mirrors what would be found in the formal requirements and in the elements of the Manufacturing Data Package and Logistics Support Plan described back in the section titled Existing Standards and Methods To Support Required Development. The concept and realization of an integrated system design that satisfies manifold requirements under pre-specified constraints and subject to configuration control are essential to this invention.

One embodiment of the handheld library is shown in FIG. 6, and it will be described in depth momentarily. The design synergistically combines elements from numerous disparate knowledge bases and sources including but not limited to classroom planning; organizational capital and operations budgeting; systems engineering; logistics management; physical security and loss prevention; information and Internet security; optical and electronic systems design; man-machine interface design; and multiple consumer, industrial, and defense products and concepts.

The device performance requirement is to allow a student of the public school system to read a book indoors in climate controlled spaces with normal ambient light as easily and successfully as he or she can when reading a standard text book. Students use their books mostly inside classrooms or inside their homes. While they sometimes read them under the open sky, such is an extremely small part of the usage, and for many students it virtually never happens. Any capability beyond indoors readability must be evaluated against the system acquisition, deployment, and support costs, and it must not negatively impact the affordability. E-ink allows indoors and outdoors readability because it works like regular ink. Other existing display technologies are not so versatile, and future display technologies may or may not be.

FIG. 6 depicts the top side of the preferred embodiment. A conspicuous physical feature readily distinguishes this item from the vast majority of other packages of similar form, in this case a protruding handle by which a student can carry it. The top side comprises an exterior case structure 44 with a handle 46. There is a display screen 48 and a control panel 50 whereon are located the device external controls.

The dimensions of the enclosure are approximately the size of a large text page with margin around it to allow for controls, interfaces, internal electronics, and handheld library structure. The display screen 48 is 34.3 centimeter (13.5 inches) in the diagonal. This allows display of a 21.6 centimeter×27.9 centimeter (8.5×11 inch) page. The overall measurements are 33.0 centimeter wide×29.2 centimeter high×1.8 centimeter deep (13 inches×11.5 inches×0.7 inch). This does not include handle 46. Handle 46 projects 6.4 centimeter (2.5 inches) from the side of the device and is 12.7 centimeter (5 inches) long. The weight is 1.9 kilograms (4.2 pounds). This is much heavier than the e-novel readers, and the difference reflects both the larger size of the handheld library and the hardening features. Compared to a book bag full of text books, the handheld library is wonderfully light and compact.

The exterior of the device is a metal enclosure with a conspicuous finish such as a bright orange alloy. Alternatively the color could be part of a hard-to-remove paint baked onto the surface. Similarly the material could be hard plastic or another lightweight, rigid material rather than metal. The sides and bottom have the same color as the top. Alternatively they could be different colors. A multi-color scheme will enhance the anti-theft feature to the extent that it contributes to the conspicuousness and particularly when it allows rapid association with a specific organizational owner.

The controls include the Power switch 52, the four way selector (4 Way) 54, the Selector button 56, the Menu button 58, and the Zoom button 60. The controls are water resistant pressure switches except the 4 Way 54, a water resistant switch with up and down and side to side movement ability in a single plane. That is to say that there is no function accessible by pressing the 4 Way 54 switch downwards or pulling it upwards with respect to the interior of the handheld library. Touch-screen technology is not used, but it could be. In this embodiment the added capabilities of touch-screen are not needed, so the cost is not justified.

An RFID tab 62 is located at the top of the case just above the display. On both sides of the display area marking areas 64a and 64b are provided for prominently engraving “School System Property” or another prominent label. Other indicia applied to the marking areas 64a and 64b or elsewhere on the handheld library may further provide ownership details such as a serial number, school system or school name, or similar identification details or iconic symbols. A bar code would also be applied to complement the RFID for electronic identification. Similar markings may be found on one or more of the sides and the bottom. The engraved labels are not colored a contrasting color in the baseline configuration, but they could be. The top surface is bolted to the lower assembly by six screws 66a though 66f. Each screw 66 screws into a recess in the bottom cover. To each screw 66 thread cement is applied during manufacture to restrain loosening to a controlled degree but not to prevent intentional removal for maintenance or repairs.

FIG. 7 depicts one side of the invention. The surface includes a plurality of interface ports current at the time of manufacture or during any subsequent modernization. In the figure are depicted three USB ports 68a, 68b, and 68c and one LAN port 70. An additional Ethernet connection is a wireless antenna. It is not visible because it is inside the handheld library, which is the current norm. The Ethernet connections are compatible with school system LANs and with the Internet. There is no CD or DVD tray in the preferred embodiment. New interfaces expected to be deployed may also be incorporated, and obsolescent interfaces may be provided to support back-fit compatibility. Additionally an electrical outlet 72 for power is provided. The baseline device has a standard power socket that allows insertion of the hot plug from an external power supply which is not part of the handheld library. The power connector interface may be 6 volt, 12 volt, or other voltage according to the systems design and the state of battery technology at the time. Primary power for the handheld library comes from the battery, which is rechargeable. A molded rubber sheet acting as a perimeter gasket and as a shock isolation sheet (gasket-isolation sheet) 74 separates the top and bottom covers. In the preferred embodiment the other sides are unbroken and without special features except for gasket-isolation sheet 74. Any of the interfaces depicted in FIG. 9 may be moved to one or more of the other surfaces, including the top or bottom, if the system engineering indicates that is the best solution for a given set of user requirements.

The internal structure is generally of the four layer sandwich that was described earlier as a current successful e-novel reader design except that the handheld library has five layers plus a thin, water resistant sheet under the top cover. Gasket-isolation sheet 74 is a single molded piece of rubber that closely fits the bottom cover and to the PCB-display-upper sheet assembly. The top and bottom covers each have a channel along their inside lips, and gasket and isolation sheet 74 fits into and seals those channels. Closely fitting and cushioning the perimeter and pre-selected contact and mounting points throughout the handheld library, rubber gasket and isolation sheet 74 provides shock protection, vibration isolation, and resistance against water and dust intrusion.

The display is an e-ink approach. There is no backlight. The display is overlaid on the external side with a 0.64 centimeter (0.25 inch) sheet of display glass to provide structural hardening with excellent transmissivity. A water resistant gasket extends around the cut out area over the display. The area to which the top cover is attached is itself isolated from the top cover by a very thin, water resistant, polymer sheet with a cut out for the display area. The top cover attaches to the bottom cover directly by screws 66a through 66f. The top and bottom covers are aluminum, but other strong, light weight, impermeable materials such as molded plastic or aluminum-magnesium alloy are satisfactory. Running cross-wise in both the bottom and top covers, that is to say in the short horizontal dimension when the device faces up toward the user, are anti-flexure ribs that provide stiffness and resist compression of the surface. All exterior interfaces are physically leak-resistant and dust-resistant using techniques well understood in the industry.

Display screen 48 is large enough to represent a full page of text clearly for students or users within the range of physical performance specified by the school system or agency ordering the device. This includes a range of font display sizes to accommodate corrected visual acuity and other physical capabilities. The device is designed for indoor use under ambient light. If anti-glare features of the display glass require augmentation for some customers, such is accomplished by applied filter coatings. The maximum off center viewing angle is wide enough to allow a teacher looking over the student's shoulder to clearly read the same page. To accommodate maps stretching over two pages electronic zoom in and out allows viewing the whole map at once as well as magnified views of small parts. The need to have a reasonably large surface for presenting maps, cutaway drawings, process charts, timelines, and other graphic materials of potentially considerable extent is why the relatively large page size is specified. The alternate approach of abutting two separate screens may result in artifacts that reduce the value of the display.

The handheld library receiver-storage-display processor is an 800 MHz CPU similar to those currently used in e-novel readers. There is 128 MB of RAM and 3 GB of flash memory plus whatever caches the selected processor brings along. The preferred embodiment does not have the resources to allow the device to download current commercially available e-textbooks which require a full function computer. This is because the uncertainty of continued Microsoft Corporation support to Windows XP makes such compatibility to not be worth the additional design, development, production, and support complexity in the preferred embodiment. Nonetheless, the issue of whether to provide this compatibility will be determined by a business decision for each implementation. More powerful or less powerful electronic components and alternate design approaches that may succeed current approaches to provide similar functions may be substituted in accordance with systems engineering trade off analyses at the time.

The computer and display performance details of the device with respect to selectivity of font size and other variables of readability are the same as used in e-reader and electronic text devices currently on sale. Given that e-ink is used, readability both indoors and under sunlight is provided. There is no backlight. No advances in computer or display technology are needed. References, instructional material, and practices pertaining to the design and development of these features are well understood in the display industry and available in textbooks as well as in international standards such as were previously identified. Such design and manufacture are being done by multiple companies in numerous countries in North America, Europe, and Asia.

Features for Compliance with Other Requirements

The requirements for ruggedness are provided in the strong, rigid structure; the anti-flexure ribs; the glass display cover; and the water and shock isolation of the rubber mountings, gaskets, and sheets. The shock isolation features provide isolation and protection from vibration as well. Additional hardening techniques that were identified earlier and are well-proven in the industry may be easily added. The selection of the final configuration typically reflects weight, cost, and anti-theft considerations in addition to the exact degree of hardness required in the environmental parameters for each user supported.

The nominal hardening requirements for the handheld library are similar to those for semi-hardened computers.
Shock 1: To be able to operate without degradation after a 30 inch fall to asphalt or to industrial grade carpet over concrete. This corresponds to being dropped from an underarm carriage position for an approximately six foot tall person or to being knocked off a standard desk.
Shock 2: To be able to operate without degradation after being struck by a hard object of the same weight from a 30 inch elevation above the handheld library.
Spill Resistance: To be able to operate without degradation after having a pint of water poured evenly within 3 seconds onto the device from any angle from a container at the same elevation as the test object. The water drains off immediately except where it forms puddles. If such puddles form, a test person representing the user will manually and gently drain the water immediately.
Test methods will be selected from MIL-STD-810 or the IEC standards. Multiple repetitions of each test will be performed. Whether the units are operating during the application of the environmental stresses or are turned on afterward will be part of the test planning. The nominal hardening requirements may be restated to an equivalent final performance requirement metric if appropriate to better fit the test plan. It may also be changed in severity according to market and system engineering requirements.

Whichever one of the hardening standards is used will be a business decision based on which of the two seems most likely to provide the strongest and most credible assurance for school administrators and reference custodian organizations. Each has its advantages. Similarly the decision as to whether to have testing done by an independent laboratory or not is also a business decision.

Theft resistance accrues inherently from physical and functional features. The former include the conspicuous color, the presence of the unusual carrying handle, and the identification indicia. Functional and physical design, including design of the controls, will ensure very limited functionality of the handheld library for anything other than its official purpose. The visual characteristics make possession of the item by anyone not appearing to be a student or a parent immediately suspicious to a law enforcement officer or, within a few years of implementation, to most citizens. It will be particularly suspicious to observe anyone in possession of several of them. A parent or teacher should be able to provide adequate proof of their reason for having an appropriate number, but a distributor of stolen goods should find it discouragingly difficult.

The final step to making the handheld library safe from theft is to have an explicit requirement that, unless explicitly authorized otherwise, the processor, memory, and other components are not at the leading edge of technology nor of exceptional power or other distinguishing feature to the extent that they make the device attractive to thieves for its parts by themselves. Devices that are pedestrian make terrible revenue generators in the stolen goods market.

Information assurance and security are provided in several ways. One is in having software that can check any web site's PKI certificate to confirm its identity before engaging. In the preferred embodiment there is a hard block against engaging any site not authenticated first. Acceptable alternative approaches are (1) to not provide such a barrier and (2) to make it an optional ON-OFF feature under the organizational owner's selection. Another IA feature in the preferred embodiment is that the URLs that can be engaged are pre-selected by the system administrator, and no one else is able to change them. This can be implemented with crystal controls or other physical approaches or in software. As with the hard block against sites trigger-able by authentication failure, URL limiting can be withheld or made optional. In addition to enhancing IA this latter feature enhances the theft resistance by severely restricting the application of the machines to anything not mission related. Another blocking capability is provided via software and hardware blocks on ports and antennae as needed to implement local security policy.

The handheld library utilizes single sign-on authentication, and it only requires that when restricted files have been requested by the operator. As will be shown in the Operation of the Preferred Embodiment, the negative possible outcomes of use by an unauthorized person are of minor enough magnitude to dispense with normal log in procedures in most cases. Single sign-on allows the handheld library to automate all the steps of a download task once the sign-on, if required, has been completed. This is optimal for youngsters still learning patience.

The handheld library has and uses file verification software to confirm the integrity of downloads both at the time of loading and at any time thereafter. The handheld library is able to recognize digital signatures attached to downloaded materials when such are used. This provides protection for materials downloaded through interfaces not protected by the measures described earlier.

These interfaces include USB ports to which may be attached a CD reader or any number of other sources. The software can authenticate downloads prior to downloading them and again, if desired, prior to playing them. The handheld library also has anti-virus and Internet security software installed to protect against malware in all data. This includes malware in data within the handheld library and data entering the machine through any interface. Modification of all software is restricted by use of standard database and software system security practices involving officially designated groups, roles, privileges, and access restrictions.

To meet the affordability requirement the design requirements document does exactly the opposite of what most developers and theoreticians are urging. It restricts the capabilities and features encompassed by the requirements to what is strictly necessary to replace hard copy books. The only exception is whatever other limited capabilities have a low enough marginal cost to fit within the affordability specification for the replacement and also are authorized by a disciplined change control process of some kind such as is common in the configuration control systems of engineering companies.

Given the features that will inherently make the handheld library extremely unpopular with thieves, backtrack software is not part of the preferred embodiment. An RFID is part of every handheld library for logistical, efficiency, and security purposes. If a replacement technology emerges with capabilities similar to or better than those of RFIDs, and if they have a compatible form and fit, then a compatible device for such new technology would be installed with or instead of the RFID tag.

To implement all the tasks potentially assignable to the handheld library, specific functionality is allocated to that side of the demarc. All other capabilities are allocated to devices on the supra side. The interface between the handheld library and the supra system is where the two system components interact, and the handheld library comprises the demarc objects themselves and the equipment, software, and processes on the handheld library side of the demarc only.

### Operation of the Preferred Embodiment

The handheld library has tasks and functions for system administrators, repair personnel, and the student operators and other users.

Administrator and repair personnel have the following functions that must be accommodated.
Turn on and off
Authenticate users to establish privileges
Load an inventory program(s)
Inventory onboard materials
Download books and materials into the handheld library
Perform Quality Control checks of image quality and other characteristics and functions
Delete books and other materials selectively
Download and install in the handheld library new software
Download and install in the handheld library software updates
Delete software selectively
Troubleshoot and repair in accordance with the customer's logistics strategy and plan

To minimize the unit cost of the handheld library the only troubleshooting and maintenance capabilities in the machines themselves is to run built-in test (BIT) and to display the results thereof at a high level. There are two basic ways to perform repairs and updates. In the first all other maintenance beyond BIT, including software maintenance, upgrade, deletion, and other activities, is carried out using external test equipment loaded with the appropriate routines. Such test equipment would be part of the special test equipment acquired along with the handheld libraries during the acquisition, and it would go into appropriate maintenance shops. Alternatively there might be no local maintenance, a user-to-depot strategy being employed for malfunctioning machines instead. Both strategies are employed commonly in both industry and in the support of military equipment. As with other features such a determination would be made during logistics support analyses for the specific markets and available technologies at the time. Students would be able to do the following tasks:
Turn on and off
Authenticate user if required
Select a book or other materials and open it
Download approved books and other materials not onboard
Go to a specific page or section
Turn pages forward and back
Zoom in and out and navigate around the enlarged or reduced page to the areas of interest.
Delete materials not among the loads mandated by the organizational owner

The process students would use to turn the machine on and then work their way to the page they want is illustrated in FIG. 8. The controls cited are as shown in FIG. 6. After Power switch 52 has been turned on a series of menus will appear as selected. Authentication challenge capabilities are resident in the operating system, but they are normally disabled except for students requiring access to unusual materials. For normal downloads the machine itself will authenticate the student with the download source. In the case of a specially secured download target an authentication challenge would be performed after the selection of that target by the user and before any connection to the target source is begun. Thereafter single source authentication would be used to minimize the user burden, and access would be withdrawn immediately at the conclusion of the download task.

Operators navigate between and within the menus using four way switch 54 (4 Way) and Menu switch 58 (M). Selections are made using Selector switch 56. Zooming is performed using the Zoom switch 60. Users can turn the machine off at any time by manipulating the Power switch 52. To avoid clutter this step has not been displayed in the flow chart in FIG. 8.

The first menu is the Machine Menu. The operator uses 4 Way 54 to move a cursor up or down the page. To make a selection he/she aligns the cursor with the desired choice and then presses Selector button 56. Thus when he/she has aligned the cursor as appropriate he/she selects the available book he/she wants to open, or he/she selects to download a new one. In the latter case the download process begins. The download process is highly automated in the preferred embodiment. This is to minimize the burden on the students, most of whom will still to a degree be learning to display patience in carrying out tasks.

The download process is depicted in FIG. 9. In this implementation the school has pre-loaded into the handheld library a list of books authorized for the student to access and download. Also pre-loaded are the source where the files can be located and the authentication codes needed to download them. Separately the school system has also established an account for each student with the companies from which downloads will be made. Each account indicates the items permitted to be downloaded and the number of copies of each. Normally the number of copies authorized per student will be one. These arrangements are not part of the handheld library per se or required for it but an option that provides additional controls for the school system.

When the user in the Machine Menu selects to download something new, a menu of approved choices is displayed. The student makes a selection. If the item is sensitive and restricted, such as mature reading material, the machine will issue a request for the student to log in with his or her user name and password. This is the only time when a log in is normally necessary for a student. That is because the possible negative outcomes of use by an unauthorized person except for sensitive files are very trivial. Specifically, how much damage can be done by downloading a single copy of a school book? As will be seen later, there is a control measure supported to prevent unlimited downloads. After file selection or after authentication all actions are done by the machine automatically because the handheld library implements a single sign-on authentication strategy.

If the file is not restricted, or if the authentication has been successful, the machine loads the URL for the source into the browser. Alternatively it can prepare to download the file via a USB port or other channel according to the pre-loaded instructions. If the authentication is not successful, the download process stops. More likely there would be a re-authentication after a first failure, but probably not more than twice more. Such an issue is a local security policy item that is usually implemented in software. If the download process stops, the handheld library will return to the Machine Menu.

When the target source is reached, the handheld library engages enough to check the public key infrastructure certificate to confirm the site is who it purports to be. If the check is bad, the session is terminated. If the check is good, then the two engage fully, the machine requests the file, authenticates for the user, and downloads the file. During and after the download the handheld library performs information assurance and file verification and uses checksums and other techniques to confirm the material is accurate and free from viruses and other malware. The machine disengages from the source and displays the Action Menu to the student.

Separately from the handheld library operations the source server itself notes the download and updates the local account records for the student. It posts an account update to the school system so its records are up to date. Again, these steps are an option. Given that the number of downloads for each item for each student has been pre-defined, it is extremely simple to set up algorithms to note and report downloads in excess of the authorizations. Such an outside surveillance system is one of the ways security against abuse can be maintained without having the students log in every time they want to use the handheld library. It also means students don't have to periodically respond to keep-alive inquiries to confirm that they are indeed still active.

Similar processes can be implemented for downloading files from local sources and over the various non-Internet ports.

Once a selection has been made from the onboard choices or a new item has been successfully downloaded the machine displays the Action Menu. The sequences depicted in FIG. 8 are resumed. If deletion is selected, a Double Check menu opens to confirm that decision before carrying it out. If deletion is confirmed, the book is deleted, and the Machine Menu comes on the screen again to restart the process. If instead the selection is to open the book, the Book Menu comes up. By navigating this menu the reader can go to the table of contents (ToC). In the ToC he or she can align the cursor with the section he or she wants and then press Selector switch 56 to go there. Alternatively he or she can select to go to a specific page. When this is selected a number screen appears consisting of three columns each containing a rotary number wheel. The left-most number window is illuminated. The reader uses the 4 Way 54 to set the number between 1 and 0. Then he/she moves to the center number and continues the process until all three numbers have been set. Then he or she activates Selector switch 56 to go there.

Pressing Menu switch 58 (M) at any point from the Action Menu forward or from any page will restore the last menu visited.

Whether going through the table of contents or to a specific page, the result of the selection from the Book Menu is that the desired page is opened and displayed. If the reader wants to go to another page, he or she can use the 4 Way 54 to move forward or backward in the book. For distant pages he or she can press the Menu button 58 (M), and this will take him or her back to the Action Menu. If Menu 58 (M) is pressed while at the Action Menu, it will take the reader back to the Machine Menu.

To turn the machine off the reader simply presses the Power button 52 at any time. If the reader is in a book just downloaded, the machine will display an inquiry as to whether it should be saved or deleted. As with the other choices this decision can be inputted via the 4 Way 54 and the Selector button 56. To avoid clutter this sequence is not depicted in FIG. 8.

The Zoom button 60 and a similar set of menus are used for zooming. Zooming can be to fixed magnification ratios or to ratios entered by the reader. A Zoom Menu is used. After the desired magnification has been reached the 4 Way 54 becomes a navigation button for moving up and down the page and left and right. If the Menu button 58 (M) is exercised downstream of the Zoom Menu, the machine will return to the Zoom Menu. If it is on the Zoom Menu, the machine will return to the Book Menu. To avoid clutter this sequence is not depicted in FIG. 8. If it were depicted, it would be a loop attached to the icon for Page, and it would have an additional exit path to Menu switch 58 indicated as M.

This set of processes can be implemented in other sequences and with different configurations of hardware. The benefit of the preferred embodiment is that it allows a maximum of flexibility for future growth because it relies on menus rather than buttons, and that means changes are much more easily configured. The progression through the menus will not be time consuming, especially for students who have used the handheld library before or who have developed their dexterity on text messaging devices.

### Alternative Embodiments

An alternate approach to protect the display 48 from being damaged by a falling object is to use a cover which is hinged and swings out of the way when the display is to be operated. In such case it may be appropriate to dispense with the 0.64 centimeter (0.25 inch) sheet of display glass used for protection in the preferred embodiment.

Another alternative embodiment features a no-tamper fastener to prevent the unauthorized modification of the devices. In this design a special tool is needed to remove at least one of bolts 66a though 66f which secure the top surface to the lower assembly, depending on the specific design implemented. This also prevents casual tampering. Such a tool is part of a logistics kit provided to the school system. It might be physically restricted to a specific room in a school to prevent its loss or theft such as being affixed to the school's repair person's work bench.

Another alternative embodiment is a handheld library using an alternate display mechanism rather than e-ink. In the nominal configuration the technology is an LCD display with fluorescent backlights. Other approaches are encompassed including light emitting diode (LED) backlights and the use of plasma or other alternative display technology instead of an LCD. The display technology selected is not a key to the nature or performance of the handheld library. In fact it is the other way around; the handheld library requirements are the determinant of what displays are acceptable. Future display technologies are acceptable as long as they meet or do better than the form, fit, and function of the preferred embodiment. The dimensions of the alternative embodiment are the same as the preferred embodiment except that the depth increases from 1.8 cm (0.7 inches) to 4.3 cm (1.7 inches). The weight increases to 3.8 kg (8.5 pounds). The reason the weight does not increase directly as the ratio of the increase in depth is that the density in weight per volume of the e-ink version is greater than that for the LCD unit.

The LCD-configured alternate version obtains its primary power from its external power connector, and its capabilities on its batteries are limited in accordance with the battery technology installed. In the primary alternate display design the LCD-configured machine is not designed for daylight readability. Daylight readability requires much higher brightness in the display, so this utilization constraint will make the battery power last longer. Battery technology may grow dramatically; display power requirements may decrease dramatically; or both may occur. If such occurs, and if marketing studies provide a validated requirement for daylight readability, the brightness of the alternate display may be increased to accommodate.

An alternate embodiment for the handheld library when used as a portable reference for workers in explosive atmospheres is for it to be designed, qualified, and manufactured to be I-SAFE in the atmospheres for which it is engineered.

Although the description above includes many details and specifics regarding the preferred embodiment, it should not be inferred as limiting the scope of the embodiment. Rather they illustrate important considerations and solutions for aspects of embodiments. There are different materials and design approaches to provide structural strength and environmental hardening, for example, as shown in the numerous specific alternative approaches described in the Prior Art. Change control processes are widely deployed in engineering and precision manufacturing companies around the world to support disciplined design tailoring and optimization. Affordability being a primary requirement, some desirable capabilities have intentionally been left out of the system in its current depiction. To the extent that evolving technology makes increasing capabilities and functionality possible without weakening the compliance with the requirement to focus on the specific requirements encompassing hard copy replacement, ruggedness, theft resistance, information assurance and security, and affordability, those can also be added. The demarc remains at the interface between the handheld library and any external system or device, each port or antenna being physically and functionally part of the handheld library itself.

1. A machine, comprising:
(a) a system design focused on replacing textbooks or reference books with handheld electronic end-user devices;
(b) a computer in a flat tablet form with subsystems from a group including physical structure, external enclosures, fasteners, power supply, memory, processor, controls, display, circuitry, and a plurality of electronic signals interfaces,
(c) said computer is of a size, shape, and design that said display can present a page of an authorized text book or reference at a size and in a manner that faithfully reproduces said page of said text book or shows the contents of said book at better levels of performance;
(d) a plurality of external features of a visually or tactilely conspicuous nature and distinctive character,
(e) a plurality of reinforcing structures comprising ribs, arches, doublers, triplers, box-structures, triangular structures, flanges, and similar engineered shapes and assemblies made from a group of materials including aluminum and its alloys, plastics, and glass of approximately 0.64 centimeter (0.25 inch) in thickness,
(f) a plurality of flexible, compressible, impermeable, semi-impermeable, water-resistant, and shock-isolating elements made from a group of materials including rubber, plastics, polymers, and similar natural and synthetic materials,
(g) a plurality of motion restraining elements from a group including glue, lock washers, cotter pins, and thread cement,
(h) software including an operating system, a mission application, and a security and quality application suite,
(i) which are combined, assembled, integrated, and checked out structurally, electronically, and functionally within said computer assembly,
whereby digital files representing hard copy text or audio-visual materials and other digital data in electronic form can be securely, accurately, and reliably downloaded from selected sources and securely, accurately, and reliably stored and displayed as selected in a machine which replaces said hard copy, said audio-visual materials, and said other data in public school systems and other severe service environments because it faithfully reproduces the content in usable form while offering significant advantages for institutional finances and for the health of students, researchers, and other users.

2. The machine of claim 1 wherein the systems development, manufacturing, and support documents implement an integrated combination of systems engineering plans and practices including requirements-based configuration control to provide mission features; damage resistance features; anti-theft features; and information security and assurance measures, such implementation being executed subject to defined constraints in acquisition and life cycle costs, weight, and size established to meet the requirements of the target market comprising public and private school systems as buyers and operators and their students as users;

3. The machine of claim 1 wherein said electronic signals interfaces are from a group including interfaces for Ethernet, universal serial bus (USB), IEEE 1394 interfaces, coaxial wire cable interfaces, fiber optic cable interfaces; and wireless connection via radio frequency and infrared frequency transmissions.

4. The machine of claim 1 wherein said visually or tactilely conspicuous and distinctive feature is from a group including handles and carrying straps.

5. The machine of claim 1 wherein said visually or tactilely conspicuous and distinctive feature is a conspicuous and distinctive color scheme from a group including single colors, multiple colors, and patterns.

6. The machine of claim 5 wherein said color scheme represents an institution's identity by the use of symbology including names, identification codes, official colors, logos, mascots, and similar iconic symbols.

7. The machine of claim 1 wherein said visually or tactilely conspicuous and distinctive feature is indicia from a group comprising engraving, stamping, and removal-resistant labels.

8. The machine of claim 7 wherein the indicia represents an institution's identity by the use of symbology including names, identification codes, official colors, logos, mascots, and similar iconic symbols.

9. The machine of claim 1 wherein the internal and external structure is designed and tested to ensure it can withstand accidental damage common to severe service environments comprising public schools and work sites requiring the use of references.

10. The machine of claim 9 wherein the damage is from a group of stresses including being dropped from the height of an adult-sized desk, being subjected to an impact by a similar machine dropped from the height of an adult sized desk, and being subjected to spilled beverages applied at the same level as said machine.

11. The machine of claim 9 wherein design and test processes and procedures utilize either United States Military Standard 810, the International Electrotechnical Commission standards 60529 and 62262, or a combination to ensure environmental compatibility and to provide assurance to school system buyers of the ruggedness of the products.

12. The machine of claim 1 wherein the operating system and mission application system support performance of required tasks from a group including turn said machine on and off, authenticate the operator, load an inventory program(s), inventory onboard materials, perform an automated sequence of actions to download materials from a local or remote source, load books into said machine, load audio-visual materials into said machine, load other data into said machine, perform quality control checks of image quality and other features and functions, delete materials previously loaded, download and install new software, download and install software updates, delete software, troubleshoot and repair said machine, select a book or other file and open it, go to a specific page or section within a book or other file, turn pages forward and back, and zoom in and out and navigate around any page to the areas of interest, such operations being limited or not limited to only authorized persons in accordance with the local security policy.

13. The machine of claim 1 wherein the development requirements document or the configuration control instructions, or both, includes a requirement or a preference for items less powerful, less modern, less weight-saving, or otherwise less valuable or expensive on a piece-parts basis than the most powerful, modern, weight-saving, or otherwise valuable variants available in the market or which have been formally scheduled for delivery to the market at approximately the same time said machine will itself be deliverable, thus reducing the theft value of said machine as a source of resale components.

14. The machine of claim 1 wherein the security and quality suite unilaterally, or by properly interfacing to a supra system when said machine is not disconnected therefrom and operated separately, provides information assurance, information security, and Internet security capabilities from a group including communication channel control, authentication, and file quality management.

15. The machine of claim 14 wherein the group of information assurance, information security, and Internet security capabilities further includes the use of hardware, software, or both, including the use of port and antenna blocks, to limit the download channels and targets to authorized channels and pre-defined URLs or other authorized sources.

16. The machine of claim 14 wherein the group of information assurance, information security, and Internet security capabilities further includes the use of procedures from a group including public key infrastructure certificate confirmation and the search for and recognition of pre-defined icons to confirm the identity of the source or target file being evaluated as the prospective download source or material.

17. The machine of claim 14 wherein the group of information assurance, information security, and Internet security capabilities further includes the use of hardware, software, or both to implement an expanded single sign-on process for the user.

18. The machine of claim 14 wherein the group of information assurance, information security, and Internet security capabilities further includes file verification during the download, storage, and playback activities.

19. The machine of claim 14 wherein the group of information assurance, information security, and Internet security capabilities further includes anti-malware capabilities including the detection and elimination of electronic viruses and other unsought artifacts that present themselves at the interfaces of said machine or within said machine.

20. The machine of claim 1 wherein the affordability features include logistics and support features from a group including the use of RFIDs and bar codes for inventory and other control measures and the use of a special, limited-distribution tool to open said machines for support purposes.

21. A method for replacing hard copy text and reference books and audio-visual materials and for receiving, storing, and displaying digital data in electronic form in public schools and other severe service localities, comprising:
(a) providing a machine, comprising:
(1) a system design focused on replacing textbooks or reference books with handheld electronic end-user devices;
(2) a computer in a flat tablet form with subsystems from a group including physical structure, external enclosures, fasteners, power supply, memory, processor, controls, display, circuitry, and a plurality of electronic signals interfaces,
(3) said computer is of a size, shape, and design that said display can present a page of an authorized text book or reference at a size and in a manner that faithfully reproduces said page of said text book or shows the contents of said book at better levels of performance;
(4) a plurality of external features of a visually or tactilely conspicuous nature and distinctive character,
(5) a plurality of reinforcing structures comprising ribs, arches, doublers, triplers, box-structures, triangular structures, flanges, and similar engineered shapes and assemblies made from a group of materials including aluminum and its alloys, plastics, and glass of approximately 0.64 centimeters (0.25) inch in thickness,
(6) a plurality of flexible, compressible, impermeable, semi-impermeable, water-resistant, and shock-isolating elements made from a group of materials including rubber, plastics, polymers, and similar natural and synthetic materials,
(7) a plurality of motion restraining elements from a group including glue, lock washers, cotter pins, and thread cement,
(8) software including an operating system, a mission application, and a security and quality application suite,
(9) which are combined, assembled, integrated, and checked out structurally, electronically, and functionally within said computer assembly.
(b) attaching said machine directly to, or via a hardwire, fiber-optic, or wireless connection to a network connected to, an authorized source of electronic files,
(c) performing information assurance, information security, and Internet security processes so that all parties and assets are fully protected,
(d) downloading and storing said electronic files while using file verification and information assurance, information security, and Internet security processes,
(e) operating said machine to identify, augment, cull, and maintain onboard files and display their contents,
(f) maintaining said machine and said onboard software
whereby said machine provides significant advantages for institutional finances and for the health of students, researchers, and other users when compared to the items replaced.
